(19) United States
(12) Patent Application Publication
(10) Pub. No.: US 2012/0242803 A1
(43) Pub. Date: Sep. 27, 2012

(54) STEREO IMAGE CAPTURING DEVICE, STEREO IMAGE CAPTURING METHOD, STEREO IMAGE DISPLAY DEVICE, AND PROGRAM

(76) Inventors: Kenjiro Tsuda, Kyoto (JP); Hiroaki Shimazaki, Tokyo (JP); Tatsuro Juri, Osaka (JP); Hiromichi Ono, Osaka (JP)

(21) Appl. No.: 13/513,750

(22) PCT Filed: Dec. 10, 2010
(86) PCT No.: PCT/JP2010/007186

§ 371 Date: Jun. 4, 2012

(30) Foreign Application Priority Data
Jan. 13, 2010 (JP) 2010-004514

(51) Int. Cl. H04N 13/02; H04N 13/04

(52) U.S. Cl. 348/46; 348/51; 348/E13.074; 348/E13.075; 348/E13.004; 348/E13.026

(57) ABSTRACT

A conventional device adjusts the convergence angle of its imaging unit in a manner that the left-and-right face detection areas are at the same coordinates and thus forms a stereo image that will be placed on a display screen during display, but fails to place a subject at an intended stereoscopic position. A stereo image capturing device (1000) detects a face area from a right image, detects a disparity using the left-and-right face areas, and sets the imaging parameters (the subject distance, focal length, stereo base, and convergence angle) to adjust the detected disparity to a disparity enabling the subject to be placed at an intended placement position. This device forms a stereo image having an appropriate stereoscopic effect in which a target subject is placed at an intended stereoscopic position. The device uses only a limited target area for face detection and thus requires less calculation for face detection.

### TECHNICAL FIELD

The present invention relates to an image capturing device (a stereo image capturing device) that captures a right eye image and a left eye image for stereoscopic viewing, a display device for displaying a right eye image and a left eye image captured for stereoscopic viewing, and a method, a program, and an integrated circuit used in such an image capturing device and in such a display device.

### BACKGROUND ART

When a stereo image (a three-dimensional image) of a subject is captured using a left eye camera and a right eye camera and is displayed by a display device, the subject is placed at a position that can vary depending on a disparity between the right and left images on the display screen.

FIGS. 3A to 3C are diagrams each describing the placement position of the subject. FIG. 3A shows the subject placed in front of the display screen (placed at a forward position from the display screen). FIG. 3B shows the subject placed at the display screen (placed on the display screen). FIG. 3C shows the subject placed behind the display screen (placed at a backward position from the display screen).

As shown in each of FIGS. 3A to 3C, the subject is placed at the intersection between a line connecting the right image and the right eye point and a line connecting the left image and the left eye point.

A stereo image in which the subject is placed on or around the display screen, which is for example shown in FIG. 3B, is a typical stereo image that is easy to view and safe for humans.

A stereo image that is both easy to view and safe can also be obtained (captured) under the settings with which the subject is placed in a manner that its maximum forward distance (for example, its distance in front of the screen shown in FIG. 3A) and its maximum backward distance (for example, its distance behind the screen shown in FIG. 3C) will fall within a range defined by a disparity of 1 degree (a disparity angle of 1 degree).

Also, if the disparity on the display screen in FIG. 3C increases to a value exceeding the distance between the right eye and the left eye of a human (the distance of about 5 to 7 cm), the resulting image would be difficult to be perceived as a three-dimensional image by the two eyes.

Considering these factors, conventional image capturing devices use a face detection technique and generate image data suitable for stereoscopic viewing by humans (see, for example, Patent Literature 1).

FIG. 23 shows the structure of a conventional image capturing device 900. As shown in FIG. 23, the image capturing device 900 obtains image data for right and left images and extracts the position of a face from each of the right and left images using a face detection algorithm used by a central processing unit (CPU) 10. Before the image capturing operation, the image capturing device 900 then aligns two imaging units 11 and 12 in a manner that the face positions will be at the same coordinates in the images captured by these two imaging units. In other words, the image capturing device 900 adjusts the angle of convergence of the two imaging units before performing the image capturing operation.

FIGS. 4A and 4B are diagrams describing such convergence angle adjustment performed with the conventional technique (by the conventional image capturing device 900) to place the subject on the screen. FIG. 4A schematically shows the relationship between the placement position of the subject and the display screen before the convergence angle is adjusted, and also shows the corresponding right eye and left eye images as well as the composite image of these two images. FIG. 4B schematically shows the relationship between the placement position of the subject and the display screen after the convergence angle is adjusted, and also shows the corresponding right eye and left eye images as well as the composite image of these two images.

In FIG. 4A, the subject is placed at a forward position. In other words, the subject is placed in front of the screen. To place the subject on the display screen, the device with the conventional technique (the conventional image capturing device 900) adjusts the convergence angle in a manner that the face detection areas in the right and left images will be at the same positions as shown in FIG. 4B. In this manner, the conventional device (the conventional image capturing device 900) captures (obtains) a stereo image in which the subject is placed on the display screen.

### CITATION LIST

### Patent Literature

Patent Literature 1: Japanese Unexamined Patent Publication No. 2008-22150

### SUMMARY

### Technical Problem

Although the subject can be placed on the display screen with the above conventional technique by adjusting the detected face areas of the right and left images to be at the same positions, this technique fails to place the subject at an intended position,

To overcome this difficulty, it is an object of the present invention to provide a stereo image capturing device that calculates a disparity using a result from subject detection (for example, a result from face detection) and sets an imaging parameter in a manner that the subject will be placed at an intended position based on the calculated disparity, and thereby obtains a stereo image having a stereoscopic effect and a depth intended by a photographer without an inappropriate viewing effect including a subject placed at an excessively forward position. It is another object of the present invention to provide a stereo image capturing method, a program, and an integrated circuit used in such a stereo image capturing device. It is still another object of the present invention to provide a stereo image display device for displaying such a stereo image, and a stereo image display method, a program and an integrated circuit used in such a stereo image display device.

### Solution to Problem

A first aspect of the present invention provides a stereo image capturing device including an imaging unit, a subject detection unit, a disparity detection unit, a calculation unit, and an adjustment unit.

The imaging unit captures an image of a subject and generates a first point image corresponding to a scene including the subject viewed from a first point and generates a second point image corresponding to a scene including the subject viewed from a second point different from the first point.

The subject detection unit detects a first subject area from the first point image, and detects a second subject area from the second point image.

The disparity detection unit detects disparity information indicating a binocular disparity between the first subject area included in the first point image and the second subject area included in the second point image.

The calculation unit calculates an imaging parameter to be used in capturing the image of the subject using the disparity information detected by the disparity detection unit.

The adjustment unit adjusts the imaging unit based on the imaging parameter calculated by the calculation unit.

This stereo image capturing device detects a subject area in a stereo image (a first point image and a second point image), and calculates the disparity (the disparity on the virtual (display) screen) (the binocular disparity between the first point image and the second point image) using the detected subject area. In this stereo image capturing device, the calculation unit calculates the imaging parameter with which a stereo image having a natural stereoscopic effect can be obtained using the disparity detected by the disparity detection unit (disparity information indicating the binocular disparity). The stereo image capturing device then adjusts the imaging parameter of the first imaging unit and/or the second imaging unit based on the calculated imaging parameter. The stereo image capturing device obtains a stereo image after the imaging parameter is adjusted. The resulting stereo image will be an image in which a predetermined subject is placed at a position intended by a photographer (a user), and enables appropriate stereoscopic viewing (a natural stereoscopic effect and a natural depth) without an inappropriate viewing effect including a subject placed at an excessively forward position.

A second aspect of the present invention provides the stereo image capturing device of the first aspect of the present invention in which the calculation unit calculates an imaging parameter for adjusting the disparity detected by the disparity detection unit to or toward a target disparity with which the subject is placed at a predetermined position.

This stereo image capturing device detects a subject area in a stereo image (a first point image and a second point image), and calculates the disparity (the disparity on the virtual (display) screen) (the binocular disparity between the first point image and the second point image) using the detected subject area. In this stereo image capturing device, the calculation unit calculates the imaging parameter with which the disparity detected by the disparity detection unit will be adjusted to or toward a target disparity with which the subject will be placed at a predetermined position. The stereo image capturing device then adjusts the imaging parameter of the first imaging unit and/or the second imaging unit based on the calculated imaging parameter. The stereo image capturing device obtains a stereo image after the imaging parameter is adjusted. The resulting stereo image will be an image in which a predetermined subject is placed at a position intended by a photographer (a user), and enables appropriate stereoscopic viewing (a natural stereoscopic effect and a natural depth) without an inappropriate viewing effect including a subject placed at an excessively forward position.

A third aspect of the present invention provides the stereo image capturing device of the first or second aspect of the present invention in which the subject detection unit detects the first subject area and the second subject area by using a face area of a subject person as a detection target.

The stereo image capturing device can detect the disparity using a face area of a subject person as a detection target (a subject area).

A fourth aspect of the present invention provides the stereo image capturing device of one of the first to third aspects of the present invention in which the subject detection unit detects the second subject area by using, as a subject detection target, a partial image area formed by an area of the second point image corresponding to the first subject area and a surrounding area surrounding the area of the second point image corresponding to the first subject area.

This stereo image capturing device uses only a limited image area as a target area for detecting the second subject area. This reduces calculations required for the detection, and also increases the processing speed of the stereo image capturing device.

The surrounding area is an area having a sufficient size to enable the second subject area to be detected. When, for example, the first subject area has a height h and the first point image and the second point image each have a lateral length w, the surrounding area includes an image area having the height h*the width w.

A fifth aspect of the present invention provides the stereo image capturing device of one of the first to fourth aspects of the present invention in which when a plurality of subject areas are detected by the subject detection unit, the disparity detection unit detects disparity information indicating a disparity for each of the plurality of subject areas, calculates a size of each of the detected subject areas, and determines a priority of each subject area based on the calculated size of each subject area. The calculation unit calculates the imaging parameter based on the priority of each subject area determined by the disparity detection unit.

This stereo image capturing device calculates the imaging parameter based on the priority of each subject area when a plurality of subject areas are detected.

A sixth aspect of the present invention provides the stereo image capturing device of the fifth aspect of the present invention in which when a plurality of subject areas are detected by the subject detection unit, the disparity detection unit detects a disparity for a main subject area that is a subject area having the largest size of the plurality of subject areas.

This stereo image capturing device calculates the imaging parameter using the disparity of the main subject area, and obtains a stereo image including the main subject placed in an appropriate manner.

A seventh aspect of the present invention provides the stereo image capturing device of one of the first to sixth aspects of the present invention in which when a plurality of subject areas are detected by the subject detection unit, a size of the first subject area or a size of the second subject area is calculated, and the priority of each subject area is determined based on the calculated size of each subject area. The calculation unit calculates the imaging parameter in a manner that a maximum forward distance disparity and a maximum backward distance disparity fall within a predetermined disparity range. The maximum forward distance disparity is a disparity for a subject area having the largest size of the plurality of subject areas. The maximum backward distance disparity is a disparity for a subject area having the smallest size of the plurality of subject areas.

This stereo image capturing device calculates the imaging parameter in a manner that the maximum forward distance disparity and the maximum backward distance disparity will be within the predetermined disparity range when a plurality of subject areas are detected. When a plurality of subject areas are detected, the stereo image capturing device obtains a stereo image having an appropriate stereoscopic effect in which all the subjects are placed at appropriate positions.

The predetermined disparity range refers to a range of disparity values within which the resulting stereo image will have an appropriate stereoscopic effect, and can be, for example, a range of disparity values corresponding to a stereoscopic-viewing enabling area. The stereoscopic-viewing enabling area is an area within which, for example, the absolute value of a difference between the angle α1 formed by the device and the subject and the angle β1 formed by the device and the virtual screen shown in FIG. 9A will be less than or equal to 1 degree.

An eighth aspect of the present invention provides the stereo image capturing device of the first aspect of the present invention further including a rough-disparity detection unit configured to detect, from the first point image and the second point image, a rough disparity having a first precision for a subject area other than a predetermined subject area.

The disparity detection unit detects a precise disparity having a second precision higher than the first precision for the predetermined subject area.

The adjustment unit calculates the imaging parameter based on the rough disparity and the precise disparity.

The disparity detection unit detects a precise disparity having a second precision higher than the first precision for the predetermined subject area. The imaging parameter changing unit calculates the imaging parameter based on the rough disparity and the precise disparity.

This stereo image capturing device can change the precision of disparity detection between a predetermined subject area (for example, a face area) and an area other than the predetermined subject area. This reduces calculations required for the disparity detection, and reduces the device cost and the power consumption of the stereo image capturing device.

A ninth aspect of the present invention provides the stereo image capturing device of the eighth aspect of the present invention in which the disparity detection unit detects a disparity for the predetermined subject area as a maximum forward distance disparity. The rough-disparity detection unit extracts, as a maximum backward distance disparity, a disparity for a subject area other than the predetermined subject area. The calculation unit calculates the imaging parameter in a manner that the maximum forward distance disparity and the maximum backward distance disparity fall within a predetermined disparity range.

This stereo image capturing device places a subject corresponding to a predetermined subject area (for example, a face area) at a position corresponding to the maximum forward distance disparity, and places a subject corresponding to the maximum backward distance disparity at a position corresponding to the maximum backward distance disparity. The stereo image capturing device further calculates the imaging parameter in a manner that the maximum forward distance disparity and the maximum backward distance disparity will fall within the predetermined disparity range (for example, the disparity range corresponding to the stereoscopic-viewing enabling area). This enables a subject corresponding to a predetermined subject area to be placed at an intended forward position, while enabling a subject other than the subject corresponding to the predetermined subject area to be placed at an appropriate position. As a result, the stereo image capturing device obtains a stereo image having an appropriate stereoscopic effect.

A tenth aspect of the present invention provides a stereo image display device for displaying a stereo image by displaying a first point image corresponding to a first point and a second point image corresponding to a second point. The device includes an image reproduction unit, a subject detection unit, a disparity detection unit, a determination unit, a setting unit, and a display unit.

The image reproduction unit reproduces the first point image and the second point image.

The subject detection unit detects a first subject area from the first point image and a second subject area from the second point image.

The disparity detection unit detects a disparity from the detected first subject area and the detected second subject area.

The determination unit determines display position information for achieving a natural stereoscopic effect based on the disparity detected by the disparity detection unit.

The setting unit sets a display position based on the display position information.

The display unit displays the first point image and the second point image based on the display position set by the setting unit.

This stereo image display device performs subject detection (for example, face detection) on the left and right display images (the first point image and the second point image) forming the captured stereo image, and calculates the disparity using the subject detection result. Based on the calculated disparity, the stereo image display device displays a stereo image having an appropriate stereoscopic effect and an appropriate depth.

An eleventh aspect of the present invention provides the stereo image display device of the tenth aspect of the present invention in which the determination unit determines display position information for adjusting the disparity detected by the disparity detection unit to or toward a target disparity with which the subject is placed at a predetermined position.

This stereo image display device performs subject detection (for example, face detection) on the left and right display images (the first point image and the second point image) forming the captured stereo image, and calculates the disparity using the subject detection result. Based on the calculated disparity, the stereo image display device displays a stereo image having an appropriate stereoscopic effect and an appropriate depth in which the subject is placed at a predetermined position (for example, a placement position intended by the user), without an inappropriate viewing effect including a subject placed at an excessively forward position.

A twelfth aspect of the present invention provides a stereo image capturing method used by a stereo image capturing device including an imaging unit configured to capture an image of a subject and generate a first point image corresponding to a scene including the subject viewed from a first point and generate a second point image corresponding to a scene including the subject viewed from a second point different from the first point. The stereo image capturing method includes a subject detection process, a disparity detection process, a calculation process, a changing process, and an imaging process.

In the subject detection process, a first subject area is detected from the first point image, and a second subject area is detected from the second point image.

In the disparity detection process, disparity information indicating a binocular disparity between the first subject area included in the first point image and the second subject area included in the second point image is detected.

In the calculation process, an imaging parameter to be used in capturing the image of the subject is calculated using the disparity information detected in the disparity detection process.

In the changing process, the imaging parameter of the imaging unit is adjusted based on the imaging parameter calculated in the calculation process.

In the imaging process, stereoscopic image capturing is performed by enabling the imaging unit to obtain the first point image and the second point image using the imaging parameter adjusted in the changing process.

The stereo image capturing method has the same advantageous effects as the stereo image capturing device of the first aspect of the present invention.

A thirteenth aspect of the present invention provides a program enabling a computer to implement a stereo image capturing method used by a stereo image capturing device including an imaging unit configured to capture an image of a subject and generate a first point image corresponding to a scene including the subject viewed from a first point and generate a second point image corresponding to a scene including the subject viewed from a second point different from the first point. The stereo image capturing method includes a subject detection process, a disparity detection process, a calculation process, a changing process, and an imaging process.

In the subject detection process, a first subject area is detected from the first point image, and a second subject area is detected from the second point image.

In the disparity detection process, disparity information indicating a binocular disparity between the first subject area included in the first point image and the second subject area included in the second point image is detected.

In the calculation process, an imaging parameter to be used in capturing the image of the subject is calculated using the disparity information detected in the disparity detection process.

In the changing process, the imaging parameter of the imaging unit is adjusted based on the imaging parameter calculated in the calculation process.

In the imaging process, stereoscopic image capturing is performed by enabling the imaging unit to obtain the first point image and the second point image using the imaging parameter adjusted in the changing process.

The program enabling the computer to implement the stereo image capturing method has the same advantageous effects as the stereo image capturing device of the first aspect of the present invention.

### Advantageous Effects

The present invention enables a disparity to be calculated using a result from subject detection (for example, a result from face detection), and an imaging parameter to be set in a manner that the subject will be placed at a predetermined position based on the calculated disparity, and enables a stereo image having a stereoscopic effect and a depth intended by a user to be formed without an inappropriate viewing effect including a subject placed at an excessively forward position.

### BRIEF DESCRIPTION OF DRAWINGS

FIG. 1 schematically shows the structure of a stereo image capturing device 1000 according to a first embodiment.

FIGS. 2A and 2B schematically show the structure of a first imaging unit 101 and a second imaging unit 102.

FIGS. 3A to 3C are diagrams each describing the placement position of the subject.

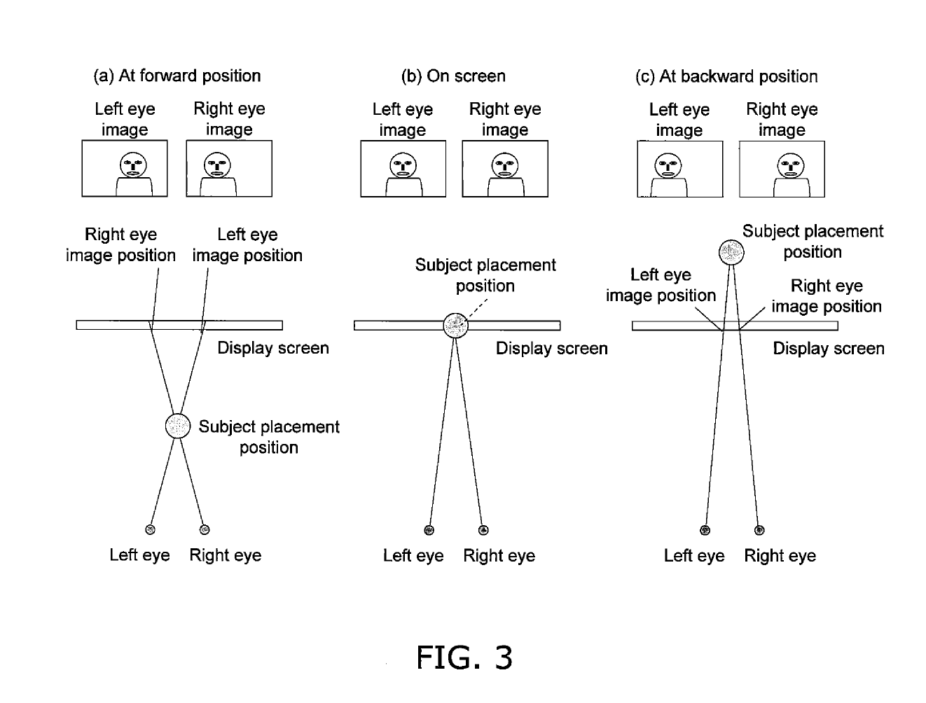

FIGS. 4A and 4B are diagrams describing adjustment of the subject placement position to a position on the screen performed by adjusting the convergence angle with a conventional technique.

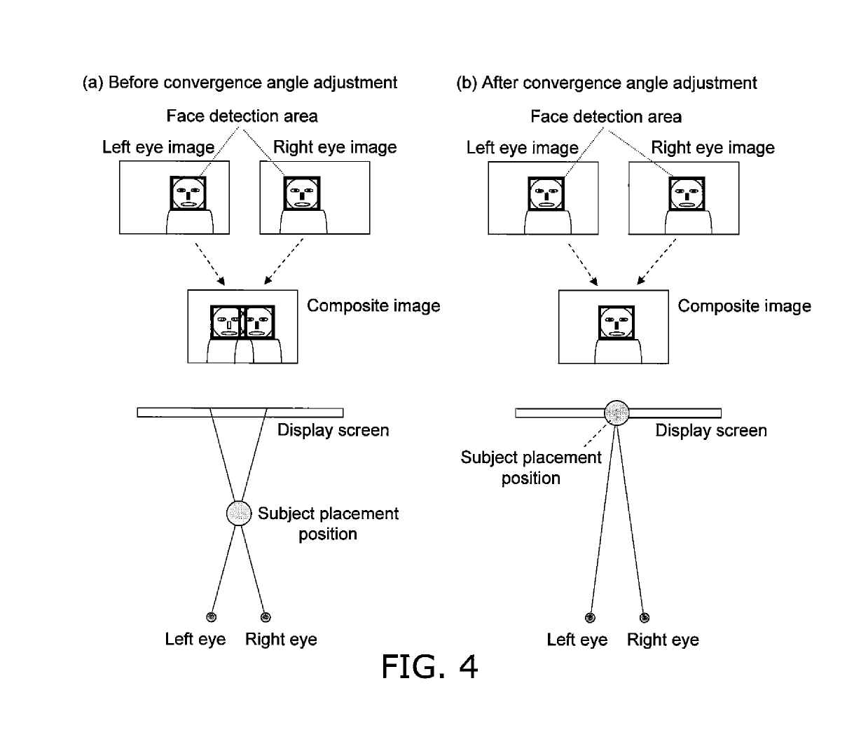

FIGS. 5A and 5B are diagrams describing an example of disparity detection performed using results from face detection.

FIGS. 6A and 6B are diagrams describing the relationship between the subject distance and the disparity.

FIGS. 7A and 7B are diagrams describing the relationship between the stereo base and the disparity.

FIGS. 8A to 8C are diagrams describing the relationship between the convergence point and the subject placement position.

FIGS. 9A and 9B are diagrams describing adjustment of the disparity on the virtual screen.

FIGS. 10A and 10B are diagrams describing adjustment of the disparity on the virtual screen.

FIG. 11 is a flowchart showing the processing performed by the stereo image capturing device 1000.

FIG. 12 schematically shows the structure of a stereo image capturing device 1000A according to a first modification.

FIG. 13 schematically shows the structure of a stereo image capturing device 1000B according to a second modification.

FIG. 14 is a diagram describing determination of a disparity detection target area based on results from face detection.

FIGS. 15A and 15B are diagrams describing determination of a disparity detection target area based on results from face detection.

FIG. 16 is a diagram describing a captured image including a subject other than a person.

FIG. 17 schematically shows the structure of a stereo image capturing device 1000C according to a third modification.

FIG. 18 is a diagram describing an example of face detection in which a plurality of face areas are detected.

FIG. 19 is a diagram describing an example of determination of the subject placement position performed for each of the plurality of detected face areas.

FIG. 20 schematically shows the structure of a stereo image display device 2000 according to a second embodiment.

FIG. 21 is a diagram describing an example of adjustment of the display position performed based on results from face detection.

FIG. 22 is a flowchart showing the processing performed by the stereo image display device 2000.

FIG. 23 is a block diagram of a stereo image capturing device according to a conventional technique.

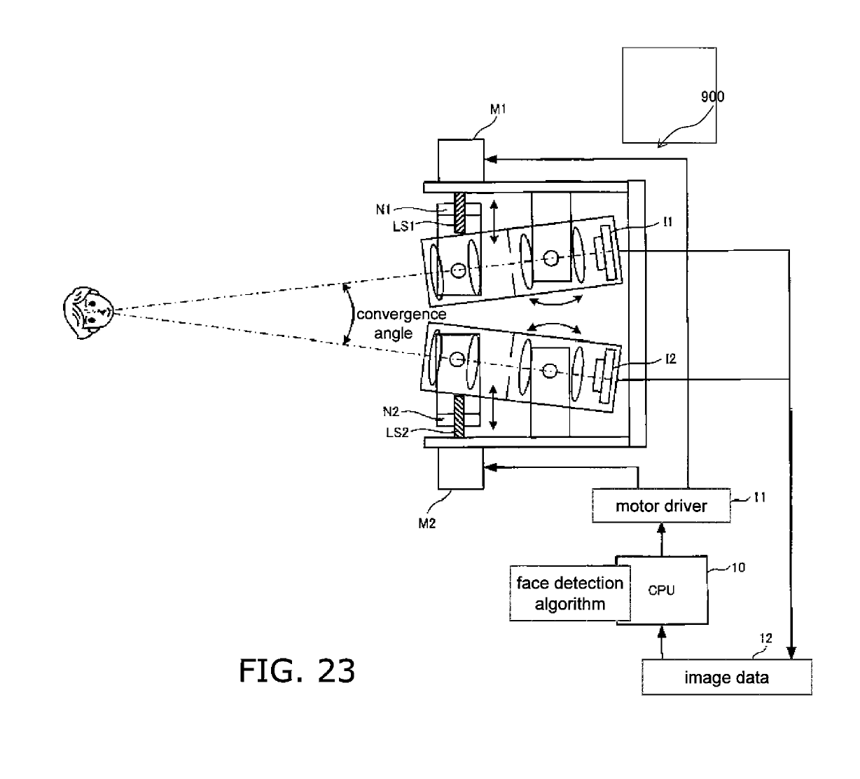

### DESCRIPTION OF EMBODIMENTS

Embodiments of the present invention will now be described with reference to the drawings.

### First Embodiment

### 1.1 Structure of the Stereo Image Capturing Device

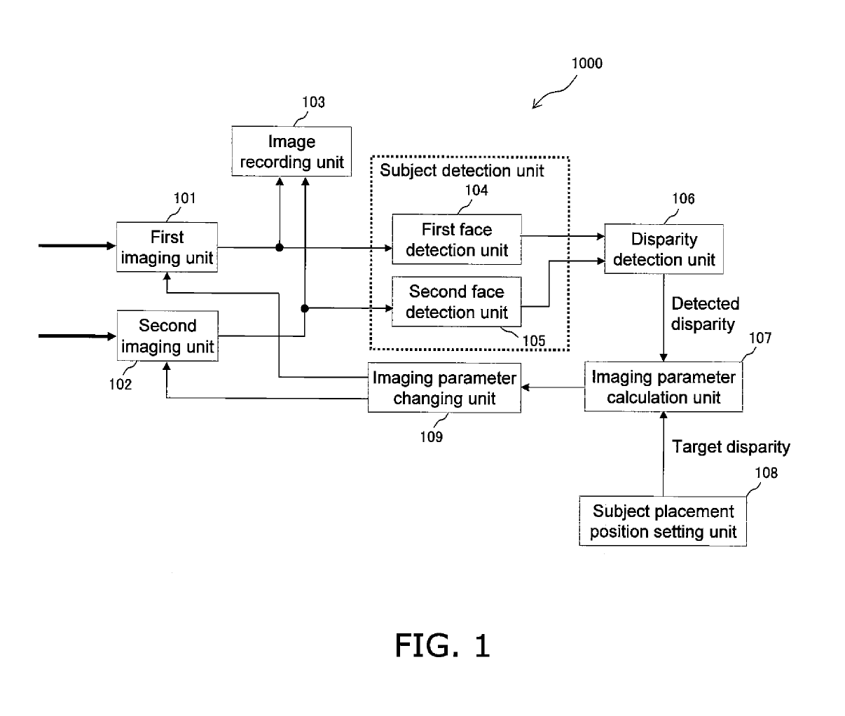

FIG. 1 schematically shows the structure of a stereo image capturing device 1000 according to a first embodiment.

As shown in FIG. 1, the stereo image capturing device 1000 includes a first imaging unit 101 and a second imaging unit 102. The first imaging unit 101 focuses light from a subject and converts the light through photoelectric conversion to obtain (form) an image signal (a video signal) as a first image signal. The second imaging unit 102 focuses light from the subject and converts the light through photoelectric conversion to obtain (form) an image signal (a video signal) as a second image signal.

The stereo image capturing device 1000 further includes a first face detection unit 104, a second face detection unit 105, and an image recording unit 103. The first face detection unit 104 performs face detection using the first image signal output from the first imaging unit 101. The second face detection unit 105 performs face detection (in which an image area forming a face is detected from an image) using the second image signal output from the second imaging unit 102. The image recording unit 103 records the first image signal and the second image signal.

The stereo image capturing device 1000 further includes a disparity detection unit 106 and a subject placement position setting unit 108. The disparity detection unit 106 detects a disparity using an output from the first face detection unit 104 and an output from the second face detection unit 105. The subject placement position setting unit 108 sets the position at which a subject is placed (the subject placement position).

The stereo image capturing device 1000 also includes an imaging parameter calculation unit 107 and an imaging parameter changing unit 109. The imaging parameter calculation unit 107 calculates an imaging parameter using the subject placement position set by the subject placement position setting unit 108 and the disparity detected by the disparity detection unit 106. The imaging parameter changing unit 109 changes an imaging parameter based on the imaging parameter calculated by the imaging parameter calculation unit 107.

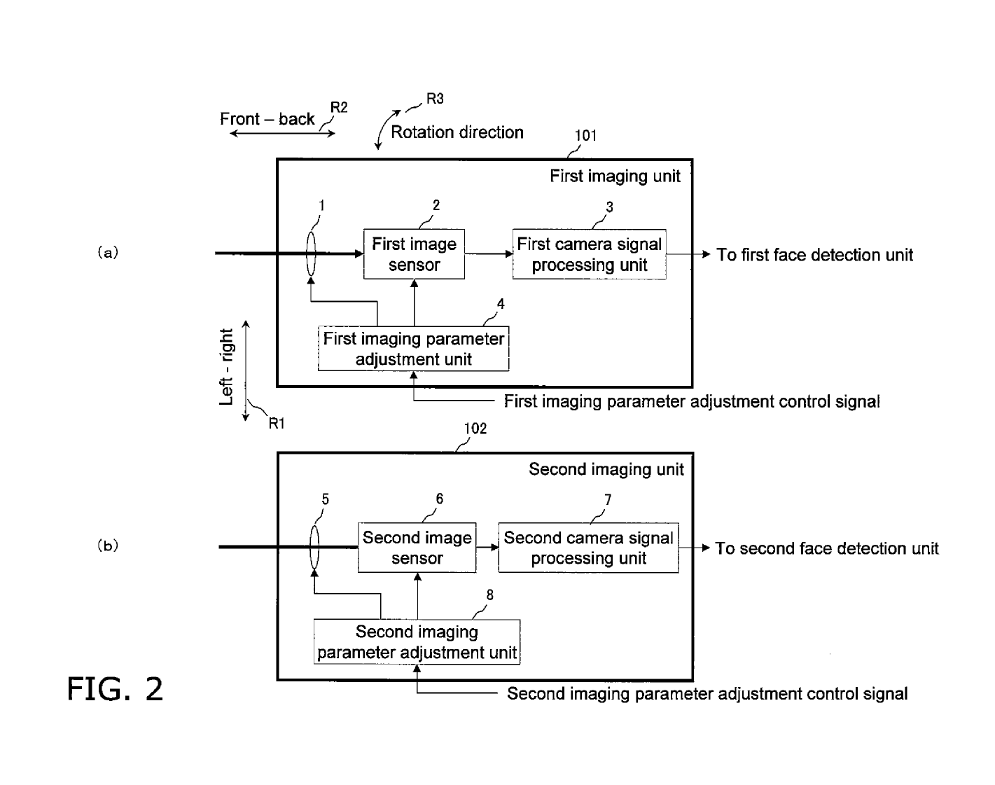

As shown in FIG. 2A, the first imaging unit 101 includes a first optical system 1, a first image sensor 2, and a first camera signal processing unit 3.

The first optical system 1 focuses light from a subject in a manner that the subject light will reach the imaging surface of the first image sensor 2. The first optical system 1 includes a focusing lens, a zoom lens, and an aperture. The first optical system 1 may include a mechanism for aligning itself as controlled by the first imaging parameter adjustment unit 4. The first optical system 1 may include a plurality of lenses.

The first image sensor 2 is formed by an image sensor, such as a complementary metal oxide semiconductor (CMOS) image sensor. The first image sensor 2 converts light focused by the first optical system 1 through photoelectric conversion and obtains (forms) an image signal (a video signal) as a first image signal. The first image sensor 2 outputs the obtained first image signal to the first camera signal processing unit 3. The first image sensor 2 may include a mechanism for aligning itself as controlled by the first imaging parameter adjustment unit 4.

The first camera signal processing unit 3 receives the first image signal output from the first image sensor 2, and processes the first image signal through camera signal processing (e.g., gain adjustment, gamma correction, aperture adjustment, white balance (WB) setting, and filter processing). The first camera signal processing unit 3 outputs the first image signal processed through the camera signal processing to the first face detection unit 104 and the image recording unit 103.

The first imaging parameter adjustment unit 4 changes the imaging parameter of the first imaging unit 101 in accordance with a first imaging parameter adjustment control signal output from the imaging parameter changing unit 109. For example, the first imaging parameter adjustment unit 4 changes (adjusts) the imaging parameter of the first imaging unit 101 in the manner described below.

When the first imaging unit 101 has a single unit structure (when, for example, the components of the first imaging unit 101 are packed in a single case unit), the first imaging parameter adjustment unit 4 moves the first imaging unit 101 in accordance with a first parameter adjustment control signal, and/or aligns the components of the first imaging unit 101 to change (adjust) the imaging parameter of the first imaging unit 101. The first imaging parameter adjustment unit 4 changes the imaging parameter used by the first imaging unit 101 through, for example, the processing (A) to (E) described below.

(A) Stereo base Control

The first imaging parameter adjustment unit 4 aligns the first imaging unit 101 by moving the first imaging unit to the left or to the right (for example, in a direction indicated by an arrow R1 in FIG. 2A). This changes (adjusts) the imaging parameter (mainly the stereo base) of the first imaging unit 101.

### (B) Subject Distance Control

The first imaging parameter adjustment unit 4 aligns the first imaging unit 101 by moving the first imaging unit to the front or to the back (for example, in a direction indicated by an arrow R2 in FIG. 2A). This changes (adjusts) the imaging parameter (mainly the subject distance) of the first imaging unit 101. The subject distance refers to a distance from an object from which light is focused onto the surface of the image sensor (e.g., a charge coupled device (CCD) image sensor or a CMOS image sensor) forming the imaging unit to the camera (the stereo image capturing device). The subject distance may also be an object point distance or a conjugate distance (an object-image distance). The subject distance may be an approximate distance from the stereo image capturing device to the subject, and may for example be (1) a distance from the gravity center of the entire lens of the optical system (the first optical system 1 and/or the second optical system 5) used in the stereo image capturing device to the subject, (2) a distance from the imaging surface of the imaging unit (the first imaging unit 101 and/or the second imaging unit 102) to the subject, or (3) a distance from the gravity center (or the center) of the stereo image capturing device to the subject.

### (C) Convergence Angle (Convergence Point) Control

The first imaging parameter adjustment unit 4 sets a predetermined rotational axis, and aligns the first imaging unit 101 by rotating the first imaging unit in a rotation direction (for example, a direction indicated by an arrow R3 in FIG. 2A) about the rotational axis. This changes (adjusts) the imaging parameter (mainly the convergence angle (the convergence point)) of the first imaging unit 101.

### (D) Focal Length Control

The first imaging parameter adjustment unit 4 controls the first optical system 1 to have a predetermined focal length. This changes (adjusts) the imaging parameter (mainly the focal length) of the first imaging unit 101. The first imaging parameter adjustment unit 4 may control (for example may control the positions of) both the first optical system 1 and the first image sensor 2 to have a predetermined focal length.

(E) The first imaging unit and/or the components of the first imaging unit are aligned through all or part of the processing (A) to (D). This changes (adjusts) the parameter(s) of the first imaging unit 101.

As shown in FIG. 2B, the second imaging unit 102 includes a second optical system 5, a second image sensor 6, and a second camera signal processing unit 7.

The second optical system 5 focuses light from a subject in a manner that the subject light will reach the imaging surface of the second image sensor 6. The second optical system 5 includes a focusing lens, a zoom lens, and an aperture. The second optical system 5 may include a mechanism for aligning itself as controlled by the first imaging parameter adjustment unit 4. The second optical system 5 may include a plurality of lenses.

The second optical system 5 is arranged at a position at which it focuses light traveling from an optical path different from the path of the light focused by the first optical system 1. This enables the stereo image capturing device 1000 to obtain a stereo image.

The second image sensor 6 is formed by an image sensor such as a CMOS image sensor. The second image sensor 6 converts light focused by the second optical system 5 through photoelectric conversion and obtains (forms) an image signal (a video signal) as a second image signal. The second image sensor 6 outputs the obtained second image signal to the second camera signal processing unit 7. The second image sensor 6 may include a mechanism for aligning itself as controlled by the second imaging parameter adjustment unit 8.

The second camera signal processing unit 7 receives the second image signal output from the second image sensor 6, and processes the second image signal through camera signal processing (e.g., gain adjustment, gamma correction, aperture adjustment, white balance (WB) setting, and filter processing). The second camera signal processing unit 7 outputs the second image signal processed through the camera signal processing to the second face detection unit 105 and the image recording unit 103.

The second imaging parameter adjustment unit 8 changes the imaging parameter of the second imaging unit 102 in accordance with a second imaging parameter adjustment control signal output from the imaging parameter changing unit 109. The second imaging parameter adjustment unit 8 has the same functions as the first imaging parameter adjustment unit 4. The second imaging parameter adjustment unit 8 changes (adjusts) the imaging parameter of the second imaging unit 102 with the same method as described above for the first imaging parameter adjustment unit 4 that changes (adjusts) the imaging parameter of the first imaging unit 101.

The first face detection unit 104 performs face detection using a first image signal output from the first imaging unit 101. More specifically, the first face detection unit 104 extracts an image area forming a face part from an image formed using the first image signal, and outputs information indicating the image area (a face area) forming the extracted face part to the disparity detection unit 106.

The second face detection unit 105 performs face detection using a second image signal output from the second imaging unit 102. More specifically, the second face detection unit 105 extracts an image area forming a face part from an image formed using the second image signal, and outputs information indicating the image area (a face area) forming the extracted face part to the disparity detection unit 106.

The image recording unit 103 receives the first image signal output from the first imaging unit 101 and the second image signal output from the second imaging unit 102, and records the first image signal and the second image signal in a predetermined recording format. The first image signal and the second image signal form stereo image data. The image recording unit 103 may record the first and second image signals as the stereo image data (data in a format suitable for a stereo image). The image recording unit 103 may record the first and second image signals (the stereo image data) onto, for example, an external recording medium.

The disparity detection unit 106 receives an output from the first face detection unit 104 and an output from the second face detection unit 105, and detects the disparity using information indicating the face area detected (extracted) by the first face detection unit 104 and information indicating the face area detected (extracted) by the second face detection unit 105. The disparity detection unit 106 then outputs information indicating the detected disparity to the imaging parameter calculation unit 107.

The subject placement position setting unit 108 sets the position at which the subject is placed (the subject placement position). The subject placement position may be set in accordance with an instruction given by the user, or may be preset or automatically set in the stereo image capturing device 1000. The subject placement position setting unit 108 outputs information indicating the set subject placement position to the imaging parameter calculation unit 107.

The imaging parameter calculation unit 107 receives information indicating the subject placement position set by the subject placement position setting unit 108 and information indicating the disparity detected by the disparity detection unit 106, and calculates the imaging parameter based on the subject placement position and the detected disparity. The imaging parameter calculation unit 107 then outputs information indicating the calculated imaging parameter to the imaging parameter changing unit 109.

The imaging parameter changing unit 109 receives information indicating the imaging parameter calculated by the imaging parameter calculation unit 107. Based on the imaging parameter calculated by the imaging parameter calculation unit 107, the imaging parameter changing unit 109 generates a first imaging parameter adjustment control signal for changing (adjusting) the imaging parameter of the first imaging unit 101 and a second imaging parameter adjustment control signal for changing (adjusting) the imaging parameter of the second imaging unit 102. The imaging parameter changing unit 109 outputs the first imaging parameter adjustment control signal to the first imaging unit 101 and the second imaging parameter adjustment control signal to the second imaging unit 102.

### 1.2 Operation of the Stereo Image Capturing Device

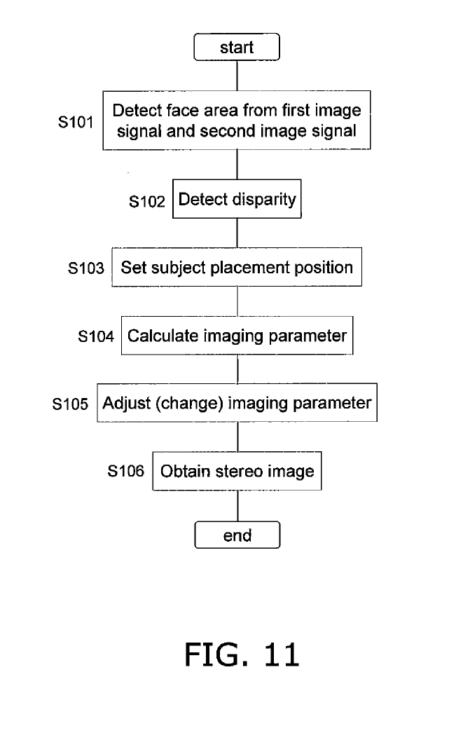

The operation of the stereo image capturing device 1000 with the above-described structure will now be described. FIG. 11 is a flowchart showing the processing corresponding to a stereo image capturing method implemented by the stereo image capturing device 1000.

### Step S101:

The first imaging unit 101 and the second imaging unit 102, which are arranged in a manner to form a stereo image, obtain a first image signal and a second image signal that will be used to form a stereo image.

The first image signal obtained (formed) by the first imaging unit 101 is output to the first face detection unit 104. The second image signal obtained (formed) by the second imaging unit 102 is output to the second face detection unit 105.

The first face detection unit 104 detects (extracts) an image area (a first face detection area) forming a face part from an image formed using the image data (the first image signal) captured (obtained) by the first imaging unit 101.

The second face detection unit 105 detects (extracts) an image area (a second face detection area) forming a face part from an image formed using the image data (the second image signal) captured (obtained) by the second imaging unit 102.

Each of the first face detection unit 104 and the second face detection unit 105 detects (extracts) the face area using a face detection algorithm known in the art. Although the present embodiment describes the case in which the stereo image capturing device 1000 detects a face area of a subject person, it may alternatively detect (extract) a subject part other than a face using color information or feature information of the subject.

Information indicating the first face area detected (extracted) by the first face detection unit 104 and information indicating the second face area detected (extracted) by the second face detection unit 105 are output to the disparity detection unit 106.

### Step S102:

The disparity detection unit 106 detects a disparity (a disparity on a virtual (display) screen) using the first face detection area detected by the first face detection unit 104 and the second face detection area detected by the second face detection unit 105.

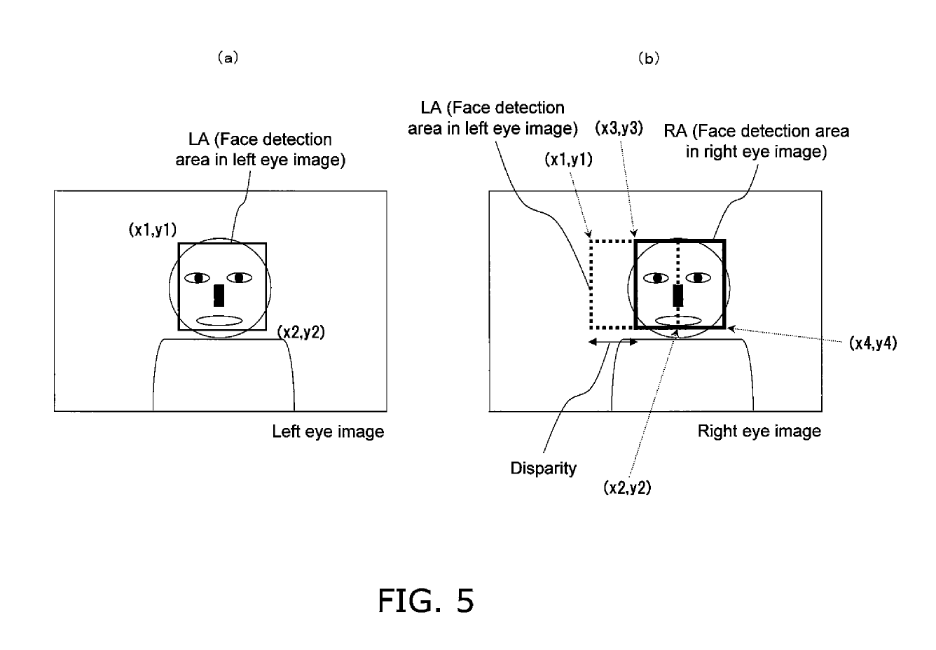

FIGS. 5A and 5B are diagrams describing an example of the processing for detecting the disparity using results from face detection. FIG. 5A schematically shows a left eye image (an image obtained by the second imaging unit 102). FIG. 5B schematically shows a right eye image (an image obtained by the first imaging unit 101).

As shown in FIGS. 5A and 5B, a rectangular face area is typically detected from an image. In this case, a disparity (a disparity on the virtual (display) screen) may be calculated as a difference in the horizontal direction between the coordinates of an upper left point of the face detection area detected in the left eye image and the corresponding upper left point of the face detection area detected in the right eye image.

In FIGS. 5A and 5B, the disparity on the virtual (display) screen is calculated as a difference between the X-coordinate x3 of the left corner point of the right eye image face detection area RA and the X-coordinate x1 of the left corner point of the let eye image face detection area LA. Although the disparity is detected using the difference in the horizontal direction between the coordinates of the upper left points of the rectangular areas in the above example, the disparity detection should not be limited to this method. For example, the disparity (the disparity on the virtual (display) screen) may be detected using a difference in the horizontal direction between the coordinates of the corresponding points in the rectangular areas or using a difference in the horizontal direction between the coordinates of the centers of the rectangular areas.

When the disparity is detected based on results from face detection, the disparity may have an error depending on the precision of the coordinates of the detected face areas. Considering this, the stereo image capturing device 1000 may perform disparity matching between the left and right face detection areas (the face detection area in the left eye image and the face detection area in the right eye image) before calculating the disparity. The disparity matching may be, for example, block matching or phase only correlation.

The disparity may be calculated in units of pixels. More specifically, the disparity detection unit 106 may calculate the disparity in units of pixels in the face detection areas, and may obtain a disparity corresponding to a maximum forward distance (a disparity with which the subject is placed at a maximum forward position) (hereafter referred to as a “maximum forward distance disparity”) and a disparity corresponding to a maximum backward distance (a disparity with which the subject is placed at a maximum backward position) (hereafter referred to as a “maximum backward distance disparity”). The disparity detection unit 106 may then output the calculated maximum forward distance disparity and the calculated maximum backward distance disparity to the imaging parameter calculation unit 107.

### Step S103:

The subject placement position setting unit 108 sets the subject placement position in accordance with an intended placement position set by a photographer (a user). Alternatively, the subject placement position setting unit 108 may automatically set the subject placement position within a range in which the resulting stereo image is easy to view and safe.

Information indicating the subject placement position set by the subject placement position setting unit 108 is output to the imaging parameter calculation unit 107.

### Step S104:

The imaging parameter calculation unit 107 calculates the imaging parameter to be set and used by each of the first imaging unit 101 and the second imaging unit 102 using the disparity detected by the disparity detection unit 106 and the subject placement position set by the subject placement position setting unit 108. More specifically, the imaging parameter calculation unit 107 calculates a target disparity with which the subject will be placed at the subject placement position set by the subject placement position setting unit 108, and calculates the imaging parameter to be set and used by each of the first imaging unit 101 and the second imaging unit 102 in a manner that the disparity detected by the disparity detection unit 106 will be adjusted to or toward the calculated target disparity (with a difference between the detected disparity and the calculated target disparity falling within a predetermined range).

Information indicating the calculated imaging parameter is then output to the imaging parameter changing unit 109.

### Imaging Parameter and Disparity Adjustment

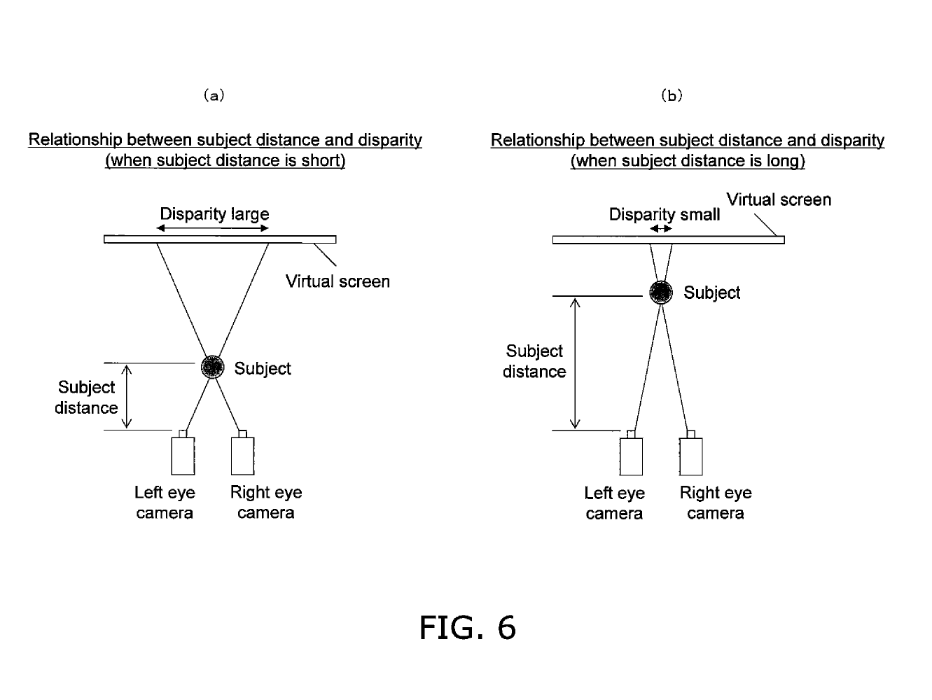

The imaging parameter and the disparity adjustment will now be described with reference to FIGS. 6A and 6B to 8A to 8C.

Examples of the imaging parameter include (1) the subject distance, (2) the stereo base, (3) the convergence angle (the convergence point), and (4) the focal length.

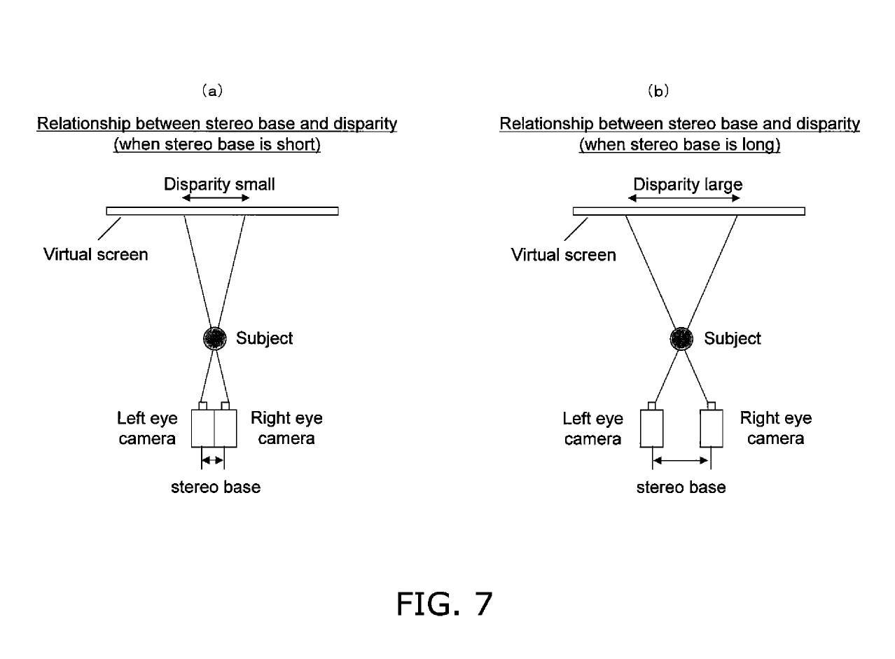

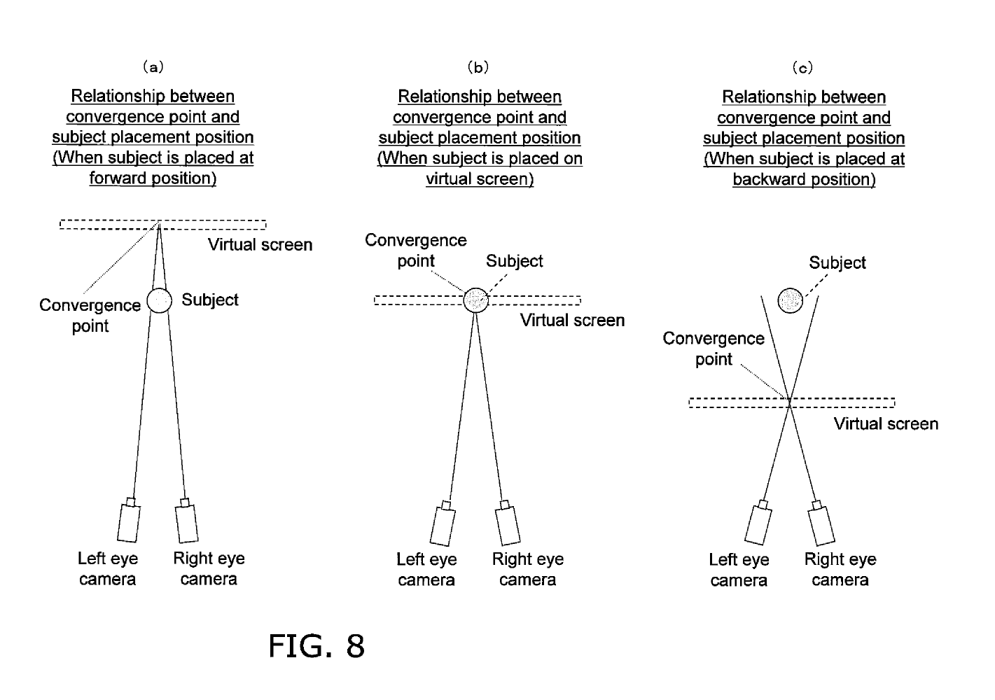

FIGS. 6A and 6B are diagrams describing the relationship between the subject distance and the disparity. FIGS. 7A and 7B are diagrams describing the relationship between the stereo base and the disparity. FIGS. 8A to 8C are diagrams describing the relationship between the convergence point and the subject placement position.

As shown in FIGS. 6A and 6B, the disparity on the virtual screen is large when the distance to the subject is short. The disparity (the disparity on the virtual screen) can be reduced by setting a long subject distance.

As shown in FIGS. 7A and 7B, the disparity on the virtual screen is large when the stereo base is long. The disparity can be reduced by setting a short stereo base between the two cameras.

As shown in FIGS. 8A to 8C, the distance between the virtual screen and the subject and the disparity on the virtual screen can further be adjusted by changing, for example, the convergence angle of the two imaging units and adjusting the convergence point.

When an image of the subject is captured under the setting of the optical system included in each imaging unit varying in its focal length, the disparity (the disparity on the virtual screen) decreases as the focal length is shorter (not shown in the figures). This means that the disparity on the virtual screen can be reduced by setting a shorter focal length of the optical system of each imaging unit.

When a subject image is captured to form a stereo image with the parallel view method, with which the two imaging units are arranged in parallel, the disparity needs to be adjusted to reflect the stereo base (the distance corresponding to the binocular disparity of a human) used in displaying the obtained stereo image. In other words, when the disparity on the virtual (display) screen of the stereo image obtained with the parallel view method is equal to or greater than the binocular disparity of a human), the stereo image cannot be fused (diverges backward). The viewer would not perceive the stereo image as a three-dimensional image but perceive it as a simple double image. The disparity needs to be adjusted in a manner to avoid this problem.

### Adjustment of Disparity on the Virtual Screen

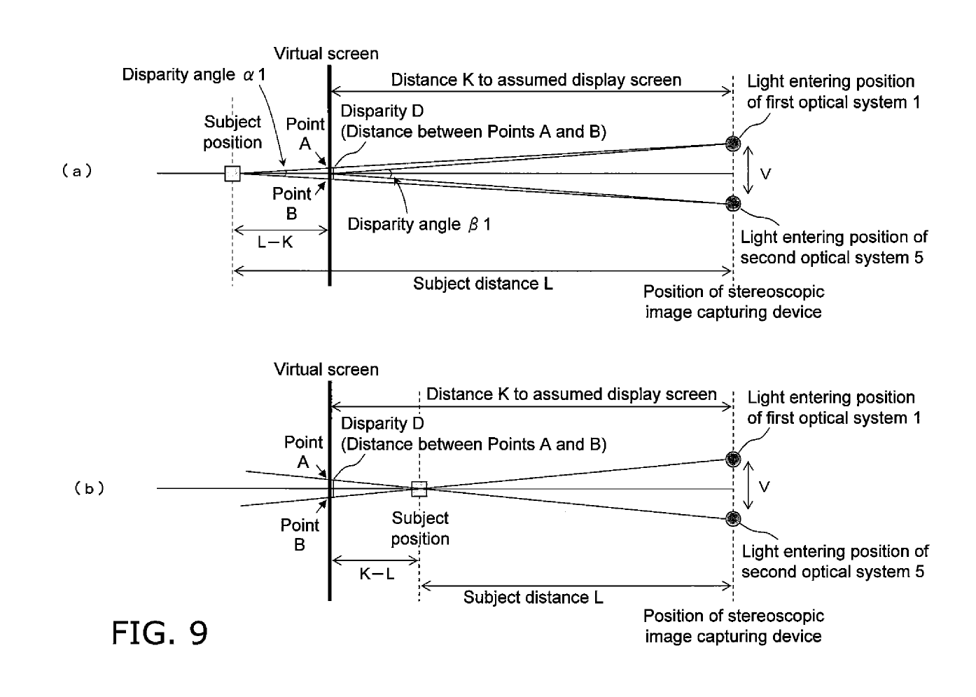

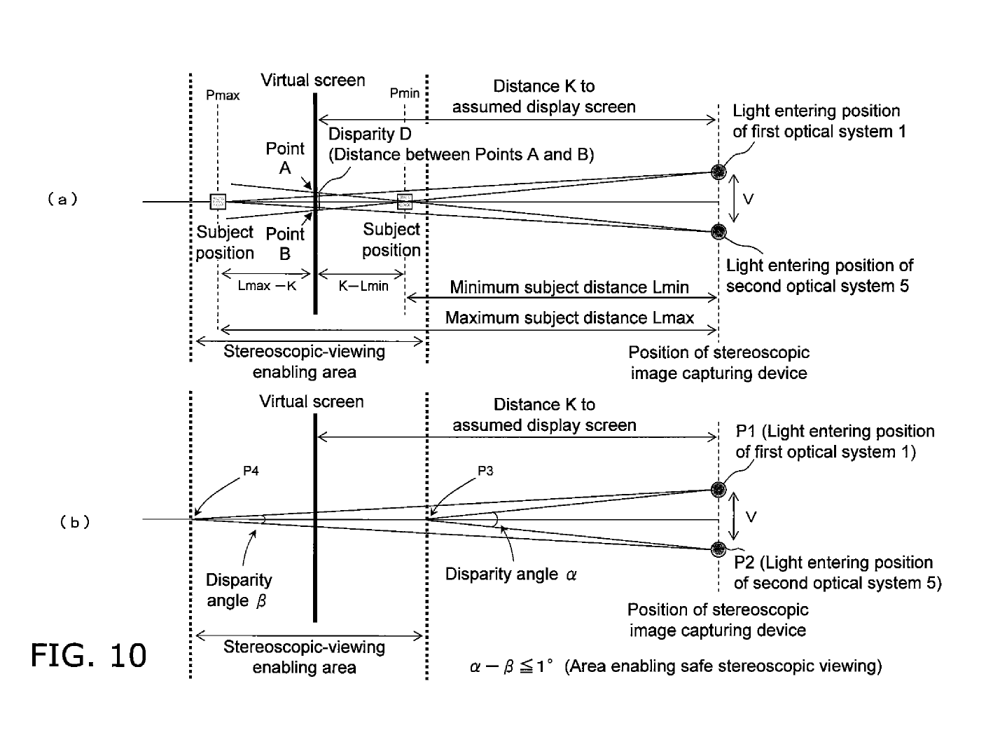

Adjustment of the disparity on the virtual screen will now be described with reference to FIGS. 9A and 9B and FIGS. 10A and 10B.

FIGS. 9A and 9B are diagrams each describing the relationship between the distance L to the subject, the distance K to the assumed display screen (the virtual screen), the stereo base V (the distance between a position at which light enters the first optical system 1 (a position at which light from the subject enters the first optical system 1, or specifically a position corresponding to the principle point of the lens of the first optical system 1 when the optical system is assumed to consist of the single lens) and a position at which light enters the second optical system 5), and the disparity D on the assumed display screen (the virtual screen). The light entering position should not be limited to the position corresponding to the principle point of the lens, but may be any position in the stereo image capturing device 1000, such as the gravity center of the entire lens or the sensor surface (the imaging surface) of the first or second imaging unit 101 or 102.

As shown in FIG. 9A, the disparity D (backward) can be calculated using the equation below when the subject is behind the assumed display screen (the virtual screen).

D=(L−K)*V/L

As shown in FIG. 9B, the disparity D (forward) can be calculated using the equation below when the subject is in front of the assumed display screen (the virtual screen).

D=−(L−K)*V/L

As shown in FIG. 10A, it is preferable to adjust the disparity D in the stereo image capturing device 1000 in a manner that an area between positions Pmin and Pmax will fall within an area in which a stereo image can be fused by common viewers (in an area in which safe stereoscopic viewing is enabled). The position Pmin is the position of a subject that is nearest from the stereo image capturing device 1000 of all the subjects captured by the stereo image capturing device 1000. The position Pmax is the position of a subject most distant from the stereo image capturing device 1000 of all the subjects captured by the stereo image capturing device 1000. When the designer of the stereo image capturing device 1000 values the stereoscopic effect produced at viewing, the disparity may be set to fall within an area within which a stereo image will avoid being perceived as a double image when the image is viewed by common viewers. The disparity falling within such an area (a stereoscopic-viewing enabling area) may for example be set in a manner that the absolute value of a difference between an angle α1 formed by the device and the subject and an angle β1 formed by the device and the virtual screen shown in FIG. 9A would be less than or equal to 1 degree. A disparity falling within a stereoscopic-viewing enabling area may not be limited to the above specified disparity value, but may vary depending on the performance of the display device or on the viewing environment. The target disparity may also be set in accordance with any other reference value.

It is preferable to adjust the disparity D in the stereo image capturing device 1000 in a manner that the area between the positions Pmix to Pmax shown in FIG. 10A will fall within an area in which safe stereoscopic viewing is enabled (for example, an area included in the stereoscopic-viewing enabling area). The area in which safe stereoscopic viewing is enabled (for example, an area included in the stereoscopic-viewing enabling area) will now be described with reference to FIG. 10B.

When the stereo base is V, the position at which light enters the first optical system 1 is P1, the position at which light enters the second optical system 5 is P2, and the positions P3 and P4 are set as shown in FIG. 10B, the area between the positions P3 and P4 shown in FIG. 10B falls within an area included in the stereoscopic-viewing enabling area when an angle (disparity angle) a formed by the line P1-P3 and the line P3-P2 and an angle (3 formed by the line P1-P4 and the line P4-P2 satisfy the relationship defined by the equation below.

α−β≦1°

When the subject positions are within this area, the captured stereo image will be an image that can be fused by many viewers and be safe.

In the stereo image capturing device 1000, it is preferable that the imaging parameter calculation unit 107 calculates the imaging parameter in a manner that the area between the positions Pmin to Pmax will fall within the area in which safe stereoscopic viewing is enabled (for example, an area included in the stereoscopic-viewing enabling area).

The imaging parameter calculation unit 107 is only required to calculate the imaging parameter with which the stereo image capturing device 1000 would form a stereo image having a natural stereoscopic effect. The stereo image having a natural stereoscopic effect is, for example, (1) a stereo image with an appropriate disparity that can be fused in an appropriate manner (without being perceived as a double image) when the stereo image is viewed by the viewer, or (2) a stereo image with an appropriate disparity that has an appropriate stereoscopic effect of a predetermined object in the image (has an appropriate stereoscopic effect of the real object (e.g., reproduces unevenness in the object surface) without causing for example a phenomenon in which a predetermined object is flattened in depth (“cardboard” effect)) when the stereo image is viewed by the viewer.

The distance K from the stereo image capturing device 1000 to the assumed display screen (the virtual screen) may be set by the user, or may be set based on a reference value determined by the manufacturer at the shipment of the stereo image capturing device 1000. The subject placement position setting unit 108 may set the subject placement position or a permissible range of subject placement positions based on the distance K to the assumed display screen (the virtual screen) set as described above.

Alternatively, the distance K from the stereo image capturing device 1000 to the assumed display screen (the virtual screen) may be set by the user in accordance with his/her home environment, or may be set to a standard viewing distance (such as the distance three times the height of the screen) calculated inside the camera based on the number of inches of the screen of the user's television set registered by the user. Alternatively, a standard viewing distance may be set based on the number of inches of a standard television set assumed by the manufacturer at the shipment of the stereo image capturing device, and the distance K may be set based on the set standard viewing distance. The subject placement position setting unit 108 may set the subject placement position or a permissible range of subject placement positions based on the distance K to the assumed display screen (the virtual screen) set as described above.

Information indicating the imaging parameter calculated based on the above various factors by the imaging parameter calculation unit 107 is then output to the imaging parameter changing unit 109.

### Step S105:

The imaging parameter changing unit 109 changes the imaging parameter of the first imaging unit 101 and the second imaging unit 102 based on the imaging parameter calculated by the imaging parameter calculation unit 107 (step S105).

The imaging parameter changing unit 109 generates a first imaging parameter adjustment control signal for changing (adjusting) the imaging parameter of the first imaging unit 101 and a second imaging parameter adjustment control signal for changing (adjusting) the imaging parameter of the second imaging unit 102 based on the imaging parameter calculated by the imaging parameter calculation unit 107. The first imaging parameter adjustment control signal is output to the first imaging parameter adjustment unit 4 of the first imaging unit 101, whereas the second imaging parameter adjustment control signal is output to the second imaging parameter adjustment unit 8 of the second imaging unit 102.

The first imaging parameter adjustment unit 4 included in the first imaging unit 101 adjusts the imaging parameter of the first imaging unit 101 to the value calculated by the imaging parameter calculation unit 107 in accordance with the first imaging parameter adjustment control signal.

When the first imaging unit 101 has a single unit structure (when, for example, the components of the first imaging unit 101 are packed in a single case unit), the first imaging parameter adjustment unit 4 moves the first imaging unit in accordance with the first parameter adjustment control signal, and/or aligns the components of the first imaging unit 101 to change (adjust) the imaging parameter of the first imaging unit 101. The first imaging parameter adjustment unit 4 changes the imaging parameter used by the first imaging unit 101 through, for example, the processing (A) to (E) described below.

### (A) Stereo Base Control

The first imaging parameter adjustment unit 4 aligns the first imaging unit 101 by moving the first imaging unit to the left or to the right (for example, in the direction indicated by the arrow R1 in FIG. 2A). This changes (adjusts) the imaging parameter (mainly the stereo base) of the first imaging unit 101.

### (B) Subject Distance Control

The first imaging parameter adjustment unit 4 aligns the first imaging unit 101 by moving the first imaging unit to the front or to the back (for example, in the direction indicated by the arrow R2 in FIG. 2A). This changes (adjusts) the imaging parameter (mainly the subject distance) of the first imaging unit 101.

### (C) Convergence Angle (Convergence Point) Control

The first imaging parameter adjustment unit 4 sets a predetermined rotational axis, and aligns the first imaging unit 101 by rotating the first imaging unit in a rotation direction (for example, the direction indicated by the arrow R3 in FIG. 2A) about the rotational axis. This changes (adjusts) the imaging parameter (mainly the convergence angle (the convergence point)) of the first imaging unit 101.

### (D) Focal Length Control

The first imaging parameter adjustment unit 4 controls the first optical system 1 to have a predetermined focal length. This changes (adjusts) the imaging parameter (mainly the focal length) of the first imaging unit 101. The first imaging parameter adjustment unit 4 may control (for example may control the positions of) both the first optical system 1 and the first image sensor 2 to have a predetermined focal length.

(E) The first imaging unit and/or the components of the first imaging unit are aligned through all or part of the processing (A) to (D). This changes (adjusts) the parameter(s) of the first imaging unit 101.

The second imaging parameter adjustment unit 8 included in the second imaging unit 102 also performs the same processing as the processing performed by the first imaging parameter adjustment unit 4 included in the first imaging unit 101, and adjusts the imaging parameter(s) of the second imaging unit 102 to the value(s) calculated by the imaging parameter calculation unit 107 in accordance with the second imaging parameter adjustment control signal.

### Step S106:

With the imaging parameter(s) adjusted to the value(s) calculated by the imaging parameter calculation unit 107 as described above, the stereo image capturing device 1000 captures an image of the subject, and outputs a first image signal and a second image signal (a stereo image) obtained using the first imaging unit 101 and the second imaging unit 102 to the image recording unit 103.

The image recording unit 103 then receives the image data output from the first imaging unit 101 and the second imaging unit 102 (the first image signal and the second image signal (the stereo image)) generated through image capturing performed with the imaging parameter(s) changed by the imaging parameter changing unit 109, and records the output image data in a predetermined recording format, such as JPEG format. The image recording unit 103 may output the first image signal and the second image signal (the stereo image) to an external recording medium and records the images signals onto the external recording medium.

### Outline of First Embodiment

As described above, the stereo image capturing device 1000 of the present embodiment detects a face area in a stereo image (in each of a left eye image and a right eye image), and calculates the disparity (the disparity on the virtual (display) screen) using the detected face area (the face detection result). The stereo image capturing device 1000 then sets the imaging parameter in a manner that the subject will be placed at a predetermined placement position based on the disparity calculated to fall within an appropriate fusion area (for example, a stereoscopic-viewing enabling area). As a result, the stereo image capturing device 1000 captures (obtains) a stereo image having a stereoscopic effect or a depth intended by the photographer (the user) or a stereo image having an appropriate stereoscopic effect without an inappropriate viewing effect including a subject placed at an excessively forward position.

The stereo image capturing device 1000 may use only a limited area as a target area for face detection. In this case, the stereo image capturing device 1000 requires less calculation for face detection. This reduces the device cost and the power consumption of the stereo image capturing device 1000.

The first imaging unit 101 and the second imaging unit 102 each are an example of an imaging unit.

The first face detection unit 104 and the second face detection unit 105 each are an example of a subject detection unit.

The disparity detection unit 106 is an example of a disparity detection unit.

The imaging parameter calculation unit 107 is an example of a calculation unit.

The imaging parameter changing unit 109 is an example of an adjustment unit.

### First Modification (Only Limited Area Is Used for Face Detection)

A first modification will now be described. The components of a stereo image capturing device according to the first modification that are the same as the components described in the above embodiment will not be described.

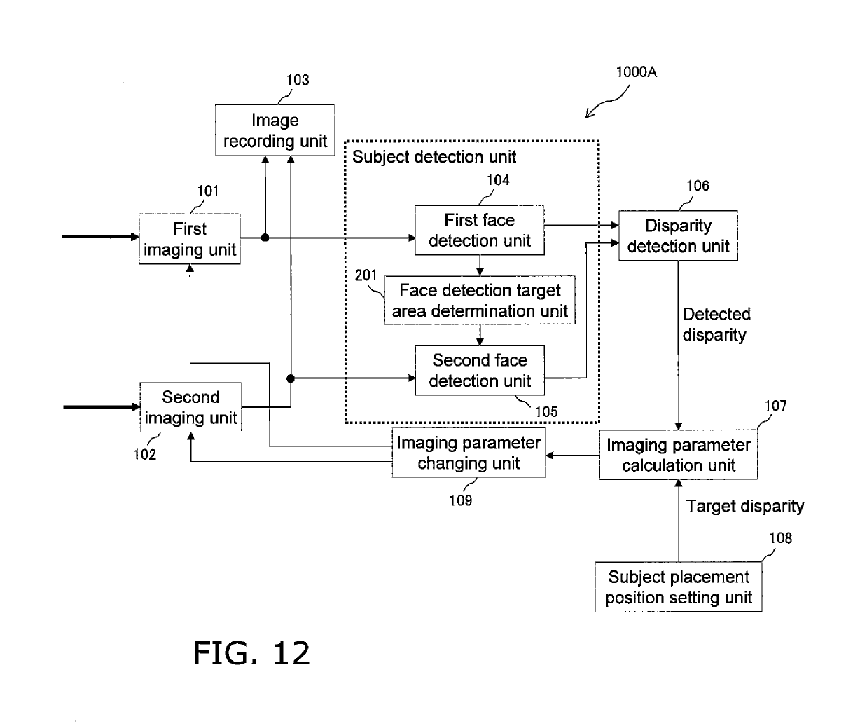

FIG. 12 schematically shows the structure of a stereo image capturing device 1000A according to the first modification.

As shown in FIG. 12, the stereo image capturing device 1000A according to the first modification has the same structure as the stereo image capturing device 1000 of the first embodiment except that it additionally includes a face detection target area determination unit 201.

In the stereo image capturing device 1000A, the second face detection unit 105 uses only a limited area of an image captured (obtained) using the second imaging unit 102 (an image formed using a first image signal) as a target area for face detection. The limited area includes an area corresponding to a face area detected by the first face detection unit 104 and its surrounding area.

More specifically, the stereo image capturing device 1000A according to the first modification uses only a limited area as a disparity detection target area based on the face detection result. This reduces the calculations required by the disparity detection and reduces the device cost and the power consumption of the stereo image capturing device.

The first face detection unit 104, the second face detection unit 105, and the face detection target area determination unit 201 each are an example of the subject detection unit.

### Second Modification (Disparity Detection Target Area Is Determined Based on Face Detection Result)

A second modification will now be described. The components of a stereo image capturing device according to the second modification that are the same as the components described in the above embodiment will not be described.

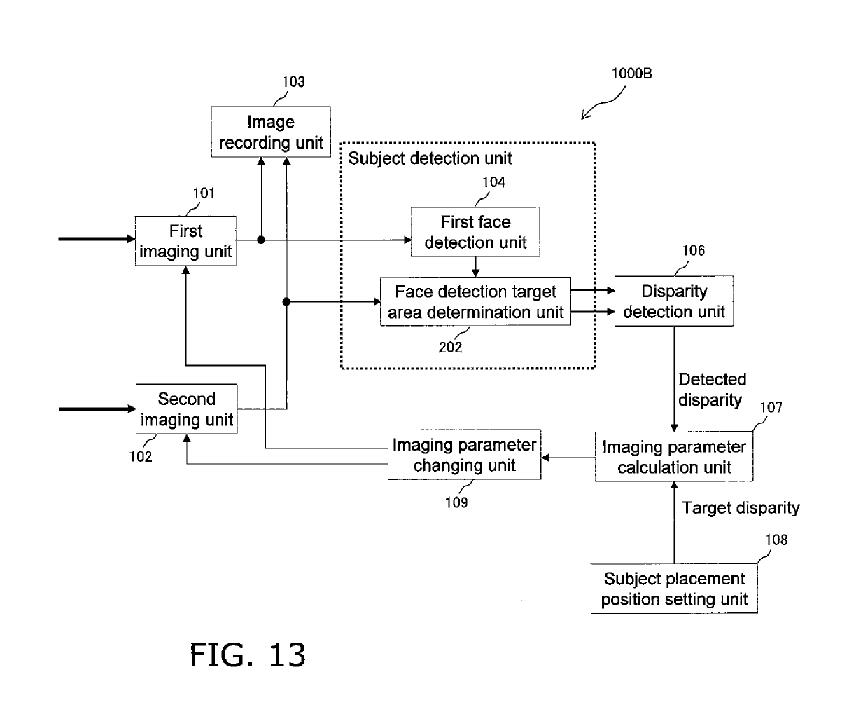

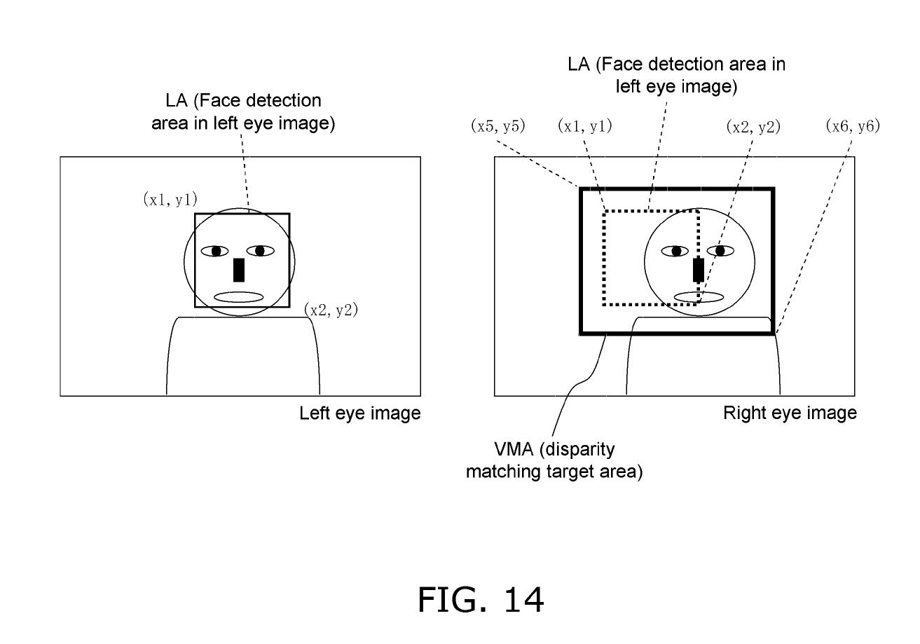

FIG. 13 schematically shows the structure of a stereo image capturing device 1000B according to the second modification. FIG. 14 is a diagram describing an example in which the disparity detection target area is determined based on the face detection result.

As shown in FIG. 13, the stereo image capturing device 1000B according to the second modification has the same structure as the stereo image capturing device 1000 of the first embodiment except that it eliminates the second face detection unit 105 and instead additionally includes a disparity detection area determination unit 202.

In the stereo image capturing device 1000B according to the second modification, the disparity detection area determination unit 202 determines a limited area of an image captured (obtained) using the second imaging unit 102 (an image formed using a second image signal) as a disparity detection target area (a disparity matching target area VMA shown in FIG. 14), based on the face detection area detected by the first face detection unit 104. The limited area includes an area corresponding to a detected face area and its surrounding area as shown in FIG. 14. In the stereo image capturing device 1000B according to the second modification, the disparity detection unit 106 detects the disparity from the disparity detection target area limited by the disparity detection area determination unit 202 included in each of the left eye image and the right eye image (the first image signal and the second image signal).

The disparity detection area determination unit 202 outputs, to the disparity detection unit 106, information indicating the face detection area detected by the first face detection unit 104, information indicating the disparity matching target area, which is the limited disparity detection target area, and information indicating the face detection area included in the image formed using the second image signal detected by the disparity matching target area.

The disparity detection unit 106 then calculates the disparity based on the information indicating the face detection area detected by the first face detection unit 104, the information indicating the disparity matching target area that is the limited disparity detection target area, and the information indicating the face detection area detected from the disparity matching target area included in the image formed using the second image signal.

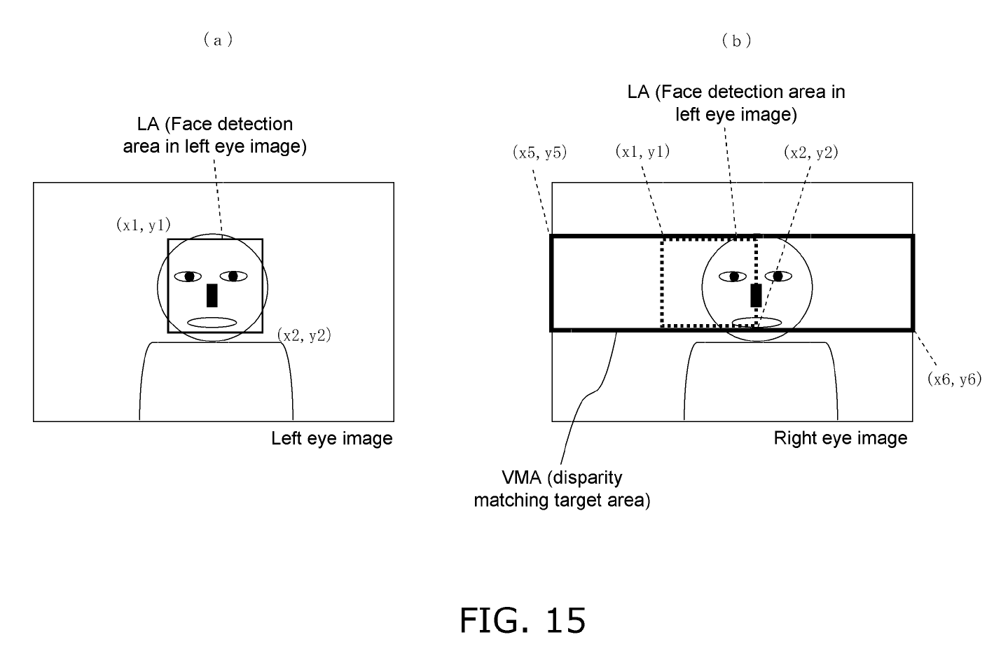

A method used by the disparity detection area determination unit 202 to set the disparity detection target area will now be described with reference to FIGS. 15A and 15B. The left eye image shown in FIG. 15A is obtained by the first imaging unit 101. The right eye image shown in FIG. 15B is obtained by the second imaging unit 102.

The first face detection unit 104 detects a left eye image face detection area LA (a rectangular area defined by (x1, y1)-(x2, y2)) as shown in FIG. 15A. The disparity detection area determination unit 202 then sets the disparity matching target area VMA as a rectangular area defined by (x5, y5)-(x6, y6) as shown in FIG. 15B, and performs face area matching in the target area.

It is preferable that the rectangular area (x5, y5)-(x6, y6) functioning as the disparity matching target area VMA is set in a manner that the vertical length of the disparity matching target area VMA is greater than or equal to the vertical length of the face detection area LA included in the left eye image and the lateral length of the disparity matching target area VMA is equal to the lateral length of the entire image (the entire valid image) (the entire image (the entire valid image) formed using the first image signal and the second image signal). More specifically, it is preferable to set the disparity matching target area VMA to satisfy the following equations:

y6−y5=y2−y1, and

x6−y5=(the lateral length(X-direction length) of the image (the valid image area)).

In FIGS. 15A and 15B, the direction to the right is a positive direction along the X axis, whereas the downward direction is a positive direction along the Y axis when the upper left corner point of the left eye image and the upper left corner point of the right eye image are assumed to be the origin.

The disparity detection area determination unit 202 sets the disparity matching target area VMA in the manner described above. This setting enables the stereo image capturing device 1000B to perform the face area matching in a reliable manner.

The first face detection unit 104 and the disparity detection area determination unit 202 each are an example of the subject detection unit.

### Third Modification (Precision of Disparity Detection Is Changed Between Face Detection Area and Other Area)

A third modification will now be described. The components of a stereo image capturing device according to the third modification that are the same as the components described in the above embodiment will not be described.

A stereo image capturing device 1000C according to the third embodiment can change the precision of disparity detection between a face detection area (a face area) and the other area.

This modification assumes the case in which the disparity is detected not only in a face detection area but also in a subject area other than the face detection area (an image area corresponding to a subject part other than the face) when a stereo image is captured (obtained).

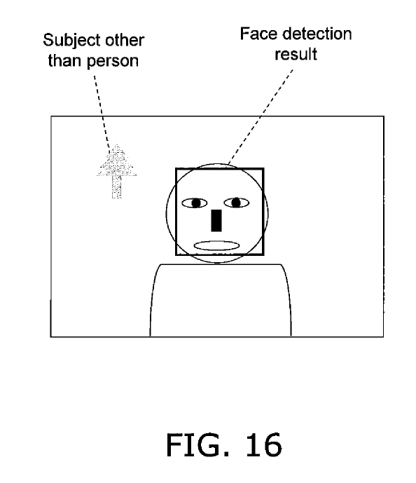

FIG. 16 schematically shows a captured image including a subject other than a person.

As shown in FIG. 16, the captured image includes a subject other than a person at a distant position. In this case, it is preferable that the stereo image capturing device detects not only the disparity for the face area included in the image but also the disparity for an image area other than the face area. In the stereo image capturing device, it is preferable that the imaging parameter calculation unit 107 calculates the imaging parameter based not only on the disparity for the face detection area but also on the disparity for an image area other than the face detection area. When, for example, the image area other than the face detection area is an area including a distant subject, the imaging parameter calculation unit 107 adjusts the imaging parameter in a manner to prevent the resulting stereo image from diverging backward (prevents the viewer from failing to fuse the stereo image). This enables the stereo image capturing device to capture a stereo image without having image failures.

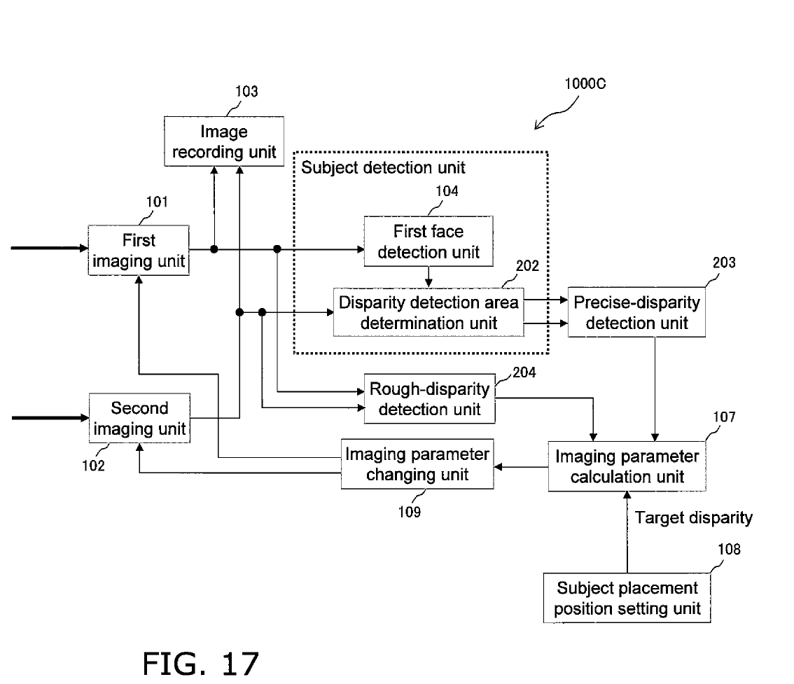

FIG. 17 schematically shows the structure of a stereo image capturing device 1000C according to the third modification.

As shown in FIG. 17, the stereo image capturing device 1000C according to the third embodiment has the same structure as the stereo image capturing device 1000 of the first embodiment except that it eliminates the second face detection unit 105 and additionally includes a disparity detection area determination unit 202, a precise-disparity detection unit 203, and a rough-disparity detection unit 204.

The stereo image capturing device 1000C performs the processing (1) and the processing (2) below in parallel.

### (1) Calculating Precise Disparity for Face Area

The precise-disparity detection unit 203 detects a precise disparity for an area limited by the disparity detection area determination unit 202 based on a face area detected by the first face detection unit 104. This processing is the same as the processing described in the second modification.

### (2) Calculating Rough Disparity for Area Other Than Face Area

The rough-disparity detection unit 204 performs the processing for detecting a disparity from image data (stereo image data) (a first image signal and a second image signal) captured (obtained) using the first imaging unit 101 and the second imaging unit 102. Through this processing, the rough-disparity detection unit 204 detects the disparity for an area other than the face area by using an image block for matching consisting of less pixels (set coarser) than an image block for face area matching (by, for example, eliminating pixels at regular intervals in the image block for matching). The rough-disparity detection unit 204 detects the disparity by subjecting the image formed using the first image signal and the image formed using the second image signal (the right eye image and the left eye image) to matching.

The imaging parameter calculation unit 107 then determines the imaging parameter using (1) the disparity calculated for the face detection area, (2) the disparity calculated for the area other than the face detection area, and the subject placement position set by the subject placement position setting unit.

As described above, the stereo image capturing device 1000C uses the face detection result, and changes the precision of disparity detection between the face detection area and the other area. This reduces calculations required for the disparity detection, and reduces the device cost and the power consumption of the stereo image capturing device.

The processing for detecting a plurality of face areas in the face detection performed by the stereo image capturing device 1000C will now be described.

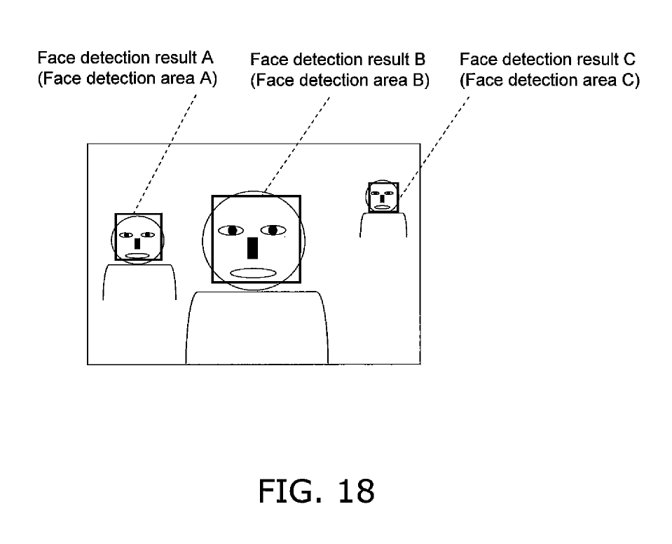

FIG. 18 schematically shows an example of an image obtained (captured) by the stereo image capturing device 1000C from which a plurality of face areas are detected.

When a plurality of subject areas are detected in an image obtained (captured) by the stereo image capturing device 1000C, the stereo image capturing device 1000C determines the priority of each subject based on the area size of its detected face area. For example, the stereo image capturing device 1000C assumes the face area with the largest size as a face area of a main subject, and detects the disparity for the largest face area and adjusts the imaging parameter using the detected disparity. The stereo image capturing device 1000C also uses the disparity for the largest (maximum) face area of the plurality of detected face areas as a maximum forward distance disparity, and uses the disparity for the smallest (minimum) face area of the detected face areas as a maximum backward distance disparity. In the stereo image capturing device 1000C, the imaging parameter calculation unit 107 then calculates the imaging parameter in a manner that the subject position corresponding to the maximum forward distance disparity and the subject position corresponding to the maximum backward distance disparity are adjusted to fall within a predetermined disparity range (for example, a stereoscopic-viewing enabling area). This enables the stereo image capturing device 1000C to capture an appropriate stereo image for all the detected subject faces.

In the example shown in FIG. 18, the subjects corresponding to the three face detection areas may all be at backward positions (in an area behind the virtual screen). In this case, the stereo image capturing device 1000C uses the disparity corresponding to the largest face area as a minimum backward distance disparity, and uses the disparity corresponding to the smallest face area as the maximum backward distance disparity. The imaging parameter calculation unit 107 then calculates the imaging parameter in a manner that the subject position corresponding to the minimum backward distance disparity and the subject position corresponding to the maximum backward distance disparity are adjusted to fall within a predetermined disparity range (for example, a stereoscopic-viewing enabling area). This enables the stereo image capturing device 1000C to capture an appropriate stereo image for all the detected subject faces.

In the example shown in FIG. 18, the subjects corresponding to the three face detection areas may all be at forward positions (in an area in front of the virtual screen). In this case, the stereo image capturing device 1000C uses the disparity corresponding to the largest face area as a maximum forward distance disparity, and uses the disparity corresponding to the smallest face area as a minimum forward distance disparity. The imaging parameter calculation unit 107 then calculates the imaging parameter in a manner that the subject position corresponding to the maximum forward distance disparity and the subject position corresponding to the minimum forward distance disparity are adjusted to fall within a predetermined disparity range (for example, a stereoscopic-viewing enabling area). This enables the stereo image capturing device 1000C to capture an appropriate stereo image for all the detected subject faces.

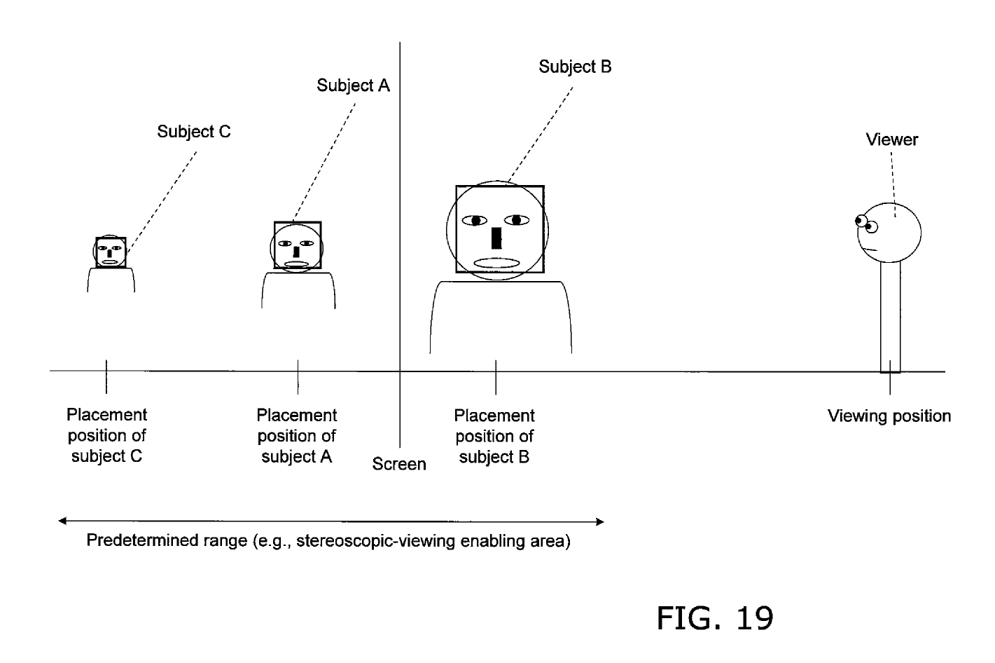

FIG. 19 is a diagram describing an example in which the subject placement position is determined for each of the plurality of face detection areas. As shown in FIG. 19, the stereo image capturing device 1000C determines the imaging parameter in a manner that, for each of the plurality of face detection area as shown in FIG. 18, a subject B having the largest face area will be placed at the most forward position as viewed from the viewer (the user), a subject A having the second largest area will be placed at the second most forward position, and a subject C having the smallest area will be placed at the most backward position, and also these placement positions of the subjects A, B, and C will fall within a predetermined range (for example, a stereoscopic-viewing enabling area).

The stereo image capturing device 1000C may first determine whether the placement position of each of the plurality of face detection areas is in front of the virtual screen (at a forward position) or behind the virtual screen (at a backward position) based on the position of each face detection area in the left eye image and the right eye image, and then determine the placement position of the subject corresponding to each face detection area. In the example shown in FIG. 19, the stereo image capturing device 1000C may perform the processing described below when the subject B is at a forward position outside the predetermined range (for example, outside the stereoscopic-viewing enabling area).

(1) The stereo image capturing device 1000C determines that the subject B is in front of the virtual screen (at a forward position).
(2) The stereo image capturing device 1000C subsequently calculates the imaging parameter in a manner that the subject B will be placed at a position nearer the virtual screen.
(3) After the calculated imaging parameter is set, the stereo image capturing device 1000C determines whether all the plurality of subjects (the subjects A, B, and C in FIG. 19) are placed at positions falling within the predetermined range (for example, within the stereoscopic-viewing enabling area).
(4) When the plurality of subjects (the subjects A, B, and C in FIG. 19) are all placed at positions falling within the predetermined range (for example, within the stereoscopic-viewing enabling area), the stereo image capturing device 1000C obtains a stereo image. When any of the plurality of subjects (the subjects A, B, and C in FIG. 19) is placed at a position outside the predetermined range (for example, outside the stereoscopic-viewing enabling area), the stereo image capturing device 1000C adjusts the imaging parameter further and repeats the above processing (1) to (3) until all the subjects (the subjects A, B, and C in FIG. 19) will be placed at positions falling within the predetermined area (for example, within the stereoscopic-viewing enabling area).

As described above, the stereo image capturing device 1000C places subjects (a plurality of persons in the present example) at positions intended by the user, and enables a stereo image having an appropriate stereoscopic effect to be captured (obtained) for all the detected subject faces (subject persons).

The first face detection unit 104 and the disparity detection area determination unit 202 each are an example of the subject detection unit.

### Second Embodiment

A second embodiment of the present invention will now be described with reference to the drawings.

### 2.1 Structure of the Stereo Image Display Device

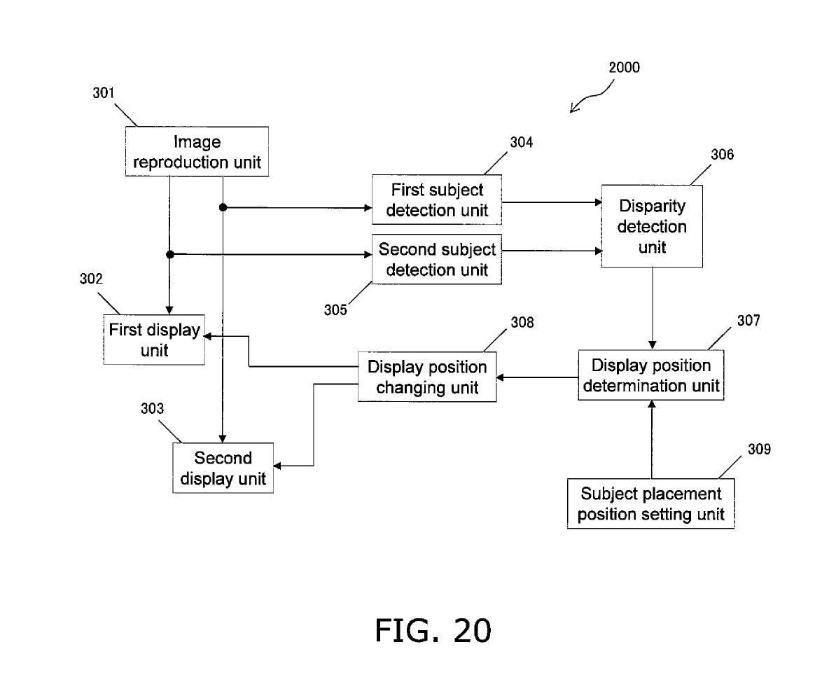

FIG. 20 schematically shows the structure of a stereo image capturing device 2000 according to a second embodiment.

As shown in FIG. 20, the stereo image capturing device 2000 includes an image reproduction unit 301, a first display unit, and a second display unit. The image reproduction unit 301 reads and reproduces a stereo image that is formed by a first point image and a second point image. The first display unit displays a first point image output from the image reproduction unit 301. The second display unit displays a second point image output from the image reproduction unit 301.

The stereo image display device 2000 further includes a first subject detection unit, a second subject detection unit 305, and a disparity detection unit 306. The first subject detection unit detects (extracts) a subject area from the first point image output from the image reproduction unit 301. The second subject detection unit 305 detects (extracts) a subject area from the second point image output from the image reproduction unit 301. The disparity detection unit 306 detects the disparity (the disparity on the display screen) based on the subject areas detected (extracted) by the first subject detection unit 304 and the second subject detection unit 305.

The stereo image display apparatus 2000 further includes a subject placement position setting unit 309, a display position determination unit 307, and a display position changing unit 308. The subject placement position setting unit 309 sets the position at which the subject is placed (the subject placement position). The display position determination unit 307 determines the display position of an image based on the disparity (the disparity on the display screen) detected by the disparity detection unit 306 and the subject placement position set by the subject placement position setting unit 309. The display position changing unit 308 controls the first display unit 302 and the second display unit 303 in a manner to change the display position of the stereo image (the first point image and the second point image) based on the display position determined by the display position determination unit 307.

The image reproduction unit 301 stores a stereo image that is formed by a first point image and a second point image. The image reproduction unit 301 reads the first point image (a video) and the second point image (a video) forming the stereo image (a video) at a predetermined timing. The image reproduction unit 301 outputs the first point image to the first display unit and the first subject detection unit 304, and outputs the second point image to the second display unit 303 and the second subject detection unit 305. The image reproduction unit 301 may read a stereo image (a video) from, for example, an external recording medium storing the stereo image (the video), and reproduce the read image.

The first display unit 302 displays the first point image output from the image reproduction unit 301 on the display screen. The first display unit 302 also adjusts (changes) the position of the first point image on the display screen in accordance with a first display unit control signal output from the display position changing unit 308.

The second display unit 303 displays the second point image output from the image reproduction unit 301 on the display screen. The second display unit 303 also adjusts (changes) the position of the second point image on the display screen in accordance with a second display unit control signal output from the display position changing unit 308.

The first subject detection unit detects (extracts) a subject area (for example, a face area) from the first point image output from the image reproduction unit 301. The subject area is detected (extracted) with the same method as described in the above embodiment. The first subject detection unit outputs information indicating the detected subject area to the disparity detection unit 306.

The second subject detection unit 305 detects (extracts) a subject area (for example, a face area) from the second point image output from the image reproduction unit 301. The subject area is detected (extracted) with the same method as described in the above embodiment. The second subject detection unit outputs information indicating the detected subject area to the disparity detection unit 306.

The disparity detection unit 306 then detects the disparity (the disparity on the display screen) based on the subject areas detected (extracted) by the first subject detection unit 304 and the second subject detection unit 305. The disparity is detected with the same method as described in the above embodiment. The disparity detection unit 306 outputs information indicating the detected disparity (the disparity on the display screen) to the display position determination unit 307.

The subject placement position setting unit 309 sets the placement position of the subject. The subject placement position may be set in accordance with an instruction from the user, or may be preset in or set automatically in the stereo image display unit 2000. The subject placement position setting unit 309 outputs information indicating the set subject placement position to the display position determination unit 307.

The display position determination unit 307 determines the display position of an image (the display position for the first point image and the display position for the second point image) based on the disparity detected by the disparity detection unit 306 (the disparity on the display screen) and the subject placement position set by the subject placement position setting unit 309. The display position determination unit 307 determines the display position in a manner that the disparity will be adjusted to an appropriate value (a disparity falling within the stereoscopic-viewing enabling area). The display position determination unit 307 then outputs information indicating the determined display position (the display position for the first point image and the display position for the second point image) to the display position changing unit 308.

The display position changing unit 308 controls the first display unit 302 and the second display unit 303 in a manner to change the display position of the stereo image (the first point image and the second point image) based on the display position determined by the display position determination unit 307. More specifically, the display position changing unit 308 generates a control signal for changing the display position of the first point image (a first display unit control signal) and a control signal for changing the display position of the second point image (a second display unit control signal). The display position changing unit 308 outputs the first display unit control signal to the first display unit 302, and outputs the second display unit control signal to the second display unit 303.

### 2.2 Operation of the Stereo Image Display Device

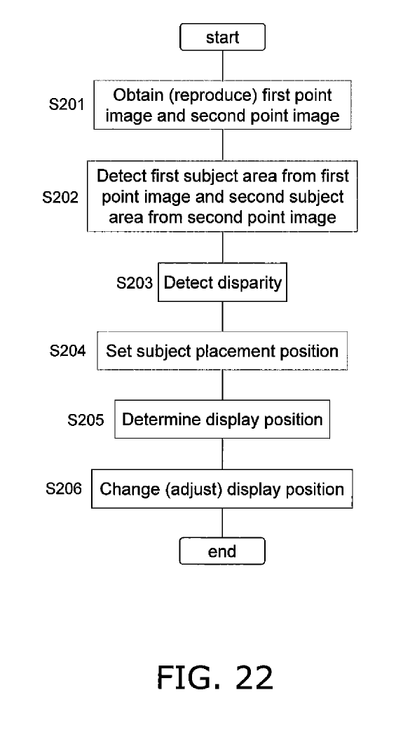

The operation of the stereo image display device 2000 with the above-described structure will now be described. FIG. 22 is a flowchart showing the processing corresponding to a stereo image capturing method implemented by the stereo image display device 2000.

### Step S201:

The image reproduction unit 301 reproduces the first point image and the second point image at a predetermined timing. The first point image is output to the first subject detection unit 304 and the first display unit 302. The second point image is output to the second subject detection unit 305 and the second display unit 303.

### Step S202:

The first subject detection unit 304 detects a subject area (a first subject area) (for example, a face area) from the first point image output from the image reproduction unit 301. Information indicating the detected first subject area is then output to the disparity detection unit 306.

The second subject detection unit 305 detects a subject area (a second subject area) (for example, a face area) from the second point image output from the image reproduction unit 301. Information indicating the detected second subject area is then output to the disparity detection unit 306.

### Step S203:

The disparity detection unit 306 detects the disparity (the disparity on the display screen) from the detected first subject area and the detected second subject area. The disparity is detected with the same method as described in the first embodiment.

### Step S204:

The subject placement position setting unit 309 sets the subject placement position as intended by the user in accordance with the setting performed by the viewer (the user). Alternatively, the subject placement position setting unit 309 may automatically set the subject placement position within the range of positions at which the resulting image will be easy to view and safe.

Information indicating the subject placement position set by the subject placement position setting unit 309 is then output to the display position determination unit 307.

### Step S205:

The display position determination unit 307 calculates (determines) the display position to be used by the first display unit 302 and the second display unit 303 based on the disparity detected by the disparity detection unit 306 and the subject placement position set by the subject placement position setting unit 309. More specifically, the display position determination unit 307 calculates a target disparity with which the subject will be placed at the subject placement position set by the subject placement position setting unit 309, and calculates the display position to be used by the first display unit 302 and the second display unit 303 in a manner that the disparity detected by the disparity detection unit 306 will be adjusted to or toward the calculated target disparity (with a difference between the detected disparity and the calculated target disparity falling within a predetermined range). Information indicating the calculated display position to be used by the first display unit 302 and the second display unit 303 is output to the display position changing unit 308.

In the present embodiment, the disparity detected by the disparity detection unit 306 is adjusted to or toward the target disparity based on the same principle as in the first embodiment. The first embodiment and the second embodiment differ from each other in that the imaging parameter is changed in the first embodiment and the display position is changed in the second embodiment.

### Step S206:

The display position changing unit 308 changes (adjusts) the display position of the first display unit 302 and the second display unit 303 based on the display position information determined by the display position determination unit 307. More specifically, the display position changing unit 308 generates a control signal for changing the display position of the first point image (a first display unit control signal) and a control signal for changing the display position of the second point image (a second display unit control signal). The first display unit control signal is output to the first display unit 302, whereas the second display unit control signal is output to the second display unit 303.

The first display unit 302 changes (adjusts) the display position of the first point image (the display position on the display screen) in accordance with the first display unit control signal.

The second display unit 303 changes (adjusts) the display position of the second point image (the display position on the display screen) in accordance with the second display unit control signal.

As described above, the stereo image display device 2000 places the subject at an intended placement position, and displays a stereo image (a video) having an appropriate stereoscopic effect.

### Display Position Adjustment Based on Face Detection Result

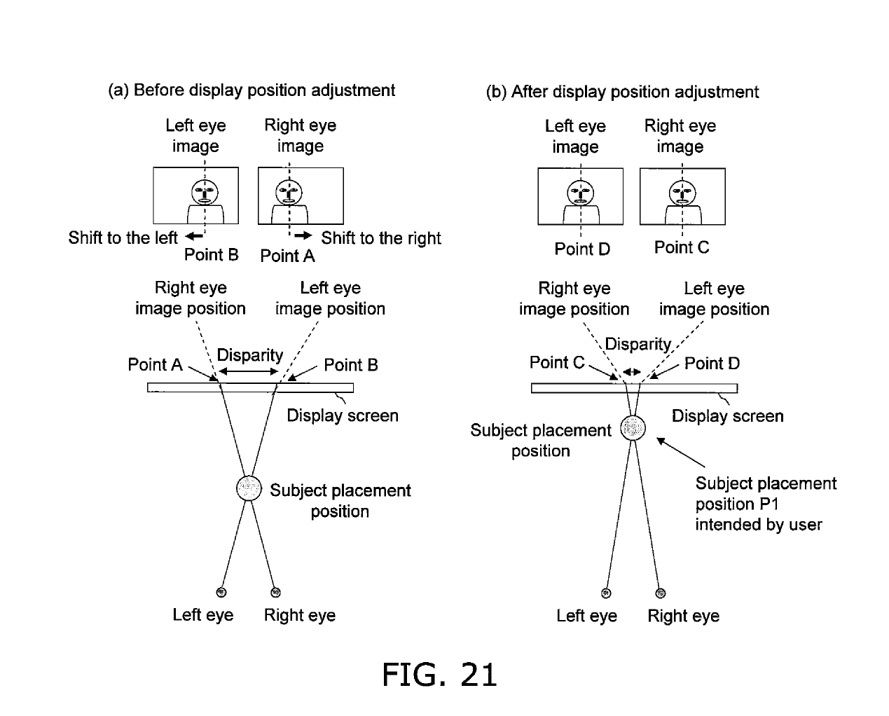

FIGS. 21A and 21B are diagrams describing an example in which the display position is adjusted based on a face detection result.

FIG. 21A schematically shows the relationship between a stereo image (a left eye image and a right eye image) before the display position is adjusted, the subject placement position, and the disparity on the display screen. FIG. 21B schematically shows the relationship between a stereo image (a left eye image and a right eye image) before the display position is adjusted, the subject placement position, and the disparity on the display screen.

When, for example, the disparity on the display screen is large and the subject placement position is at a significantly forward position from the display screen as shown in FIG. 21A, the image is difficult to view. In this case, the stereo image display device 2000 sets the subject placement position intended by the viewer (the subject placement position P1 shown in FIG. 21B), and calculates the disparity based on the set subject placement position P1. In this case, the disparity is set to decrease as shown in FIGS. 21A and 21B. The stereo image display device 2000 determines the display position in a manner that the left eye image is shifted to the left and the right eye image is shifted to the right as show in FIGS. 21A and 21B. As a result, the stereo image display device 2000 prevents the subject placement position from being an excessively forward position, and displays a stereo image in which the subject is placed at a position near the display screen as shown FIG. 21B. This enables the stereos image display device 2000 to display a stereo image that is easy to view by the user.

The processing amount for face detection and the processing amount for disparity detection required by the stereo image capturing device 2000 can be reduced by using the corresponding structure described in the first embodiment.

### Outline of Second Embodiment

As described above, the stereo image display device 2000 of the present embodiment performs face detection (subject detection) on the left and right display images forming the captured stereo image, and calculates the disparity using the face detection result (the subject detection result). The stereo image display device 2000 places the subject at a predetermined position (for example, at a position intended by the user) based on the calculated disparity, and displays a stereo image having an appropriate stereoscopic effect and an appropriate depth without an inappropriate viewing effect including a subject placed at an excessively forward position.

The image reproduction unit 301 is an example of an image reproduction unit.

The first subject detection unit 304 and the second subject detection unit 305 each are an example of a subject detection unit.

The disparity detection unit 306 is an example of a disparity detection unit.

The display position determination unit 307 is an example of a determination unit.

The display position changing unit 308 is an example of a setting unit.

The first display unit 302 and the second display unit 303 each are an example of a display unit.

### Other Embodiments

Although the above embodiments describe the case in which the two imaging units (the first imaging unit 101 and the second imaging unit 102) are used to obtain (capture) a stereo image (a left eye image and a right eye image), the present invention should not be limited to this structure. For example, the stereo image capturing device of each of the above embodiments may use only a single image sensor (an imaging unit) to alternately obtain a left eye image and a right eye image in a time divided manner. Alternatively, the stereo image capturing device of each of the above embodiments may use a single imaging unit whose imaging surface is divided into two areas, with which a left eye image and a right eye image are obtained respectively. Alternatively, the stereo image capturing device of each of the above embodiments may include a mechanism for optically switching between an optical path on which the subject light travels from the first point and an optical path on which the subject light travels from the second point to obtain a left eye image and a right eye image using a single imaging unit.

In the above embodiments, the right eye image and the left eye image forming the stereo image should not necessarily be limited to the right-left correspondence described in the above embodiments. The right component and the left component may be switched when such switching of the right-left correspondence will not disable the same processing as described in the above embodiments.

The first camera signal processing unit 3 included in the first imaging unit 101 shown in FIGS. 2A and 2B may be arranged external to the first imaging unit 101. The second camera signal processing unit 7 included in the second imaging unit 102 shown in FIGS. 2A and 2B may be arranged external to the second imaging unit 102.

In the above embodiments, the first face detection unit and the second face detection unit may be integrated into a single subject detection unit. The first image signal output from the first imaging unit and the second image signal output from the second imaging unit may be used for the subject area (for example, a face area) detection performed in a time divided manner. This reduces the circuit scale and the manufacturing cost of the stereo image capturing device.

Each block of the stereo image capturing device and/or the stereo image display device described in the above embodiments may be formed using a single chip with a semiconductor device, such as LSI (large-scale integration), or some or all of the blocks of the stereo image capturing device may be formed using a single chip.

Although LSI is used as the semiconductor device technology, the technology may be IC (integrated circuit), system LSI, super LSI, or ultra LSI depending on the degree of integration of the circuit.

The circuit integration technology employed should not be limited to LSI, but the circuit integration may be achieved using a dedicated circuit or a general-purpose processor. A field programmable gate array (FPGA), which is an LSI circuit programmable after manufactured, or a reconfigurable processor, which is an LSI circuit in which internal circuit cells are reconfigurable or more specifically the internal circuit cells can be reconnected or reset, may be used.

Further, if any circuit integration technology that can replace LSI emerges as an advancement of the semiconductor technology or as a derivative of the semiconductor technology, the technology may be used to integrate the functional blocks. Biotechnology is potentially applicable.

The processes described in the above embodiments may be implemented using either hardware or software (which may be combined together with an operating system (OS), middleware, or a predetermined library), or may be implemented using both software and hardware. When the stereo image capturing device of each of the above embodiments is implemented by hardware, the stereo image capturing device requires timing adjustment for its processes. For ease of explanation, the timing adjustment associated with various signals required in an actual hardware design is not described in detail in the above embodiments.

The processes described in the above embodiments may not be performed in the order specified in the above embodiments. The order in which the processes are performed may be changed without departing from the scope and spirit of the invention.

The present invention may also include a computer program enabling a computer to implement the method described in the above embodiments and a computer readable recording medium on which such a program is recorded. The computer readable recording medium may be, for example, a flexible disk, a hard disk, a CD-ROM, an MO, a DVD, a DVD-ROM, a DVD-RAM, a Blu-ray disc, or a semiconductor memory.

The computer program should not be limited to a program recorded on the recording medium, but may be a program transmitted with an electric communication line, a radio or cable communication line, or a network such as the Internet.

The processes described in the above embodiments may not be performed in the order specified in the above embodiments. The order in which the processes are performed may be changed without departing from the scope and spirit of the invention.

The specific structures described in the above embodiments are mere examples of the present invention, and may be changed and modified variously without departing from the scope and spirit of the invention.

### INDUSTRIAL APPLICABILITY

The stereo image capturing device, the stereo image capturing method, the stereo image display device, the stereo image display method, and the program of the present invention can be used for digital cameras and digital video cameras with stereoscopic imaging capabilities to capture and display a stereo image having an appropriate stereoscopic effect.

### REFERENCE SIGNS LIST

1000, 1000A, 1000B, 1000C stereo image capturing device
1 first optical system
2 first image sensor
3 first camera signal processing unit
4 first imaging parameter adjustment unit
5 second optical system
6 second image sensor
7 second camera signal processing unit
8 second imaging parameter adjustment unit
101 first imaging unit
102 second imaging unit
103 image recording unit
104 first face detection unit (first subject detection unit)
105 second face detection unit (second subject detection unit)
106 disparity detection unit
107 imaging parameter calculation unit
108 subject placement position setting unit
109 imaging parameter changing unit
201 face detection target area determination unit
202 disparity detection area determination unit
203 precise-disparity detection unit
204 rough-disparity detection unit
2000 stereo image display device
301 image reproduction unit
302 first display unit
303 second display unit
304 first face detection unit
305 second face detection unit
306 disparity detection unit
307 display position determination unit
308 display position changing unit
309 subject placement position setting unit

1. A stereo image capturing device, comprising:
an imaging unit configured to capture an image of a subject and generate a first point image corresponding to a scene including the subject viewed from a first point and generate a second point image corresponding to a scene including the subject viewed from a second point, the second point being different from the first point;
a subject detection unit configured to detect a first subject area from the first point image, and detect a second subject area from the second point image;
a disparity detection unit configured to detect disparity information indicating a binocular disparity between the first subject area included in the first point image and the second subject area included in the second point image;
a calculation unit configured to calculate an imaging parameter to be used in capturing the image of the subject using the disparity information detected by the disparity detection unit; and
an adjustment unit configured to adjust the imaging unit based on the imaging parameter calculated by the calculation unit.

2. The stereo image capturing device according to claim 1, wherein
the calculation unit calculates an imaging parameter for adjusting the disparity detected by the disparity detection unit to or toward a target disparity with which the subject is placed at a predetermined position.

3. The stereo image capturing device according to claim 1, wherein
the subject detection unit detects the first subject area and the second subject area by using a face area of a subject person as a detection target.

4. The stereo image capturing device according to claim 1, wherein
the subject detection unit detects the second subject area by using, as a subject detection target, a partial image area formed by an area of the second point image corresponding to the first subject area and a surrounding area surrounding the area of the second point image corresponding to the first subject area.

5. The stereo image capturing device according to claim 1, wherein
when a plurality of subject areas are detected by the subject detection unit, the disparity detection unit detects disparity information indicating a disparity for each of the plurality of subject areas, calculates a size of each of the detected subject areas, and determines a priority of each subject area based on the calculated size of each subject area, and
the calculation unit calculates the imaging parameter based on the priority of each subject area determined by the disparity detection unit.

6. The stereo image capturing device according to claim 5, wherein
when a plurality of subject areas are detected by the subject detection unit, the disparity detection unit detects a disparity for a main subject area that is a subject area having the largest size of the plurality of subject areas.

7. The stereo image capturing device according to claim 1, wherein
when a plurality of subject areas are detected by the subject detection unit, a size of the first subject area or a size of the second subject area is calculated, and the priority of each subject area is determined based on the calculated size of each subject area, and
the calculation unit calculates the imaging parameter in a manner that a maximum forward distance disparity and a maximum backward distance disparity fall within a predetermined disparity range, the maximum forward distance disparity being a disparity for a subject area having the largest size of the plurality of subject areas, the maximum backward distance disparity being a disparity for a subject area having the smallest size of the plurality of subject areas.

8. The stereo image capturing device according to claim 1, further comprising:
a rough-disparity detection unit configured to detect, from the first point image and the second point image, a rough disparity for a subject area other than a predetermined subject area, the rough disparity having a first precision,
wherein the disparity detection unit detects a precise disparity for the predetermined subject area, the precise disparity having a second precision higher than the first precision, and
the adjustment unit calculates the imaging parameter based on the rough disparity and the precise disparity.

9. The stereo image capturing device according to claim 8, wherein
the disparity detection unit detects a disparity for the predetermined subject area as a maximum forward distance disparity,
the rough-disparity detection unit extracts, as a maximum backward distance disparity, a disparity for a subject area other than the predetermined subject area, and
the calculation unit calculates the imaging parameter in a manner that the maximum forward distance disparity and the maximum backward distance disparity fall within a predetermined disparity range.

10. A stereo image display device for displaying a stereo image by displaying a first point image corresponding to a first point and a second point mage corresponding to a second point, the device comprising:
an image reproduction unit configured to reproduce the first point image and the second point image;
a subject detection unit configured to detect a first subject area from the first point image and a second subject area from the second point image;
a disparity detection unit configured to detect a disparity from the detected first subject area and the detected second subject area;
a determination unit configured to determine display position information for achieving a natural stereoscopic effect based on the disparity detected by the disparity detection unit;
a setting unit configured to set a display position based on the display position information; and
a display unit configured to display the first point image and the second point image based on the display position set by the setting unit.

11. The stereo image display device according to claim 10, wherein
the determination unit determines display position information for adjusting the disparity detected by the disparity detection unit to or toward a target disparity with which the subject is placed at a predetermined position.

12. A stereo image capturing method used by a stereo image capturing device including an imaging unit configured to capture an image of a subject and generate a first point image corresponding to a scene including the subject viewed from a first point and generate a second point image corresponding to a scene including the subject viewed from a second point, the second point being different from the first point, the method comprising:
detecting a first subject area from the first point image, and detecting a second subject area from the second point image;
detecting disparity information indicating a binocular disparity between the first subject area included in the first point image and the second subject area included in the second point image;
calculating an imaging parameter to be used in capturing the image of the subject using the disparity information detected in the disparity detection step;
adjusting the imaging parameter of the imaging unit based on the imaging parameter calculated in the calculation step; and
performing stereoscopic image capturing by enabling the imaging unit to obtain the first point image and the second point image using the imaging parameter adjusted in the adjusting step.

13. A non-transitory computer-readable recording medium storing thereon a program enabling a computer to implement a stereo image capturing method used by a stereo image capturing device including an imaging unit configured to capture an image of a subject and generate a first point image corresponding to a scene including the subject viewed from a first point and generate a second point image corresponding to a scene including the subject viewed from a second point, the second point being different from the first point, the method comprising:
detecting a first subject area from the first point image, and detecting a second subject area from the second point image;
detecting disparity information indicating a binocular disparity between the first subject area included in the first point image and the second subject area included in the second point image;
calculating an imaging parameter to be used in capturing the image of the subject using the disparity information detected in the disparity detection step;
adjusting the imaging parameter of the imaging unit based on the imaging parameter calculated in the calculation step; and
performing stereoscopic image capturing by enabling the imaging unit to obtain the first point image and the second point image using the imaging parameter adjusted in the adjusting step.
